(19) United States
(12) Patent Application Publication
(10) Pub. No.: US 2020/0125398 A1
(43) Pub. Date: Apr. 23, 2020

(54) INFORMATION PROCESSING APPARATUS, METHOD FOR PROCESSING INFORMATION, AND PROGRAM

(71) Applicant: SONY CORPORATION, TOKYO (JP)

(72) Inventors: KAZUNORI ARAKI, TOKYO (JP); SHUSUKE TAKAHASHI, CHIBA (JP)

(21) Appl. No.: 16/473,333

(22) PCT Filed: Nov. 28, 2017
(86) PCT No.: PCT/JP2017/042664

§ 371 Date: Jun. 25, 2019

(30) Foreign Application Priority Data
Jan. 25, 2017 (JP) 2017-010850

(51) Int. Cl. G06F 9/48

(52) U.S. Cl. CPC G06F 9/4831; G06F 2209/486

(57) ABSTRACT

It is desirable that a technique capable of more appropriately determining a request to be preferentially processed is provided. There is provided an information processing apparatus including a detection unit that detects a context associated with a user, and a request processing unit that determines, on the basis of the context, which of a first request and a second request should be preferentially processed.

### TECHNICAL FIELD

The present disclosure relates to an information processing apparatus, a method for processing information, and a program.

### BACKGROUND ART

In recent years, various techniques have been known as a technique of processing a request from a user. For example, a technique of determining, in a case where a new request is input in addition to a request in processing, whether or not to allow the new request to perform interruption depending on whether or not the interruption is permitted (e.g., see Patent Document 1).

### CITATION LIST

### Patent Document

Patent Document 1: Japanese Patent Application Laid-Open No. H7-121226

### SUMMARY OF THE INVENTION

### Problems to be Solved by the Invention

However, it is desirable that a technique capable of more appropriately determining a request to be preferentially processed is provided.

### Solutions to Problems

According to the present disclosure, there is provided an information processing apparatus including a detection unit that detects a context associated with a user, and a request processing unit that determines, on the basis of the context, which of a first request and a second request should be preferentially processed.

According to the present disclosure, there is provided a method for processing information including detecting the context associated with the user, and determining, on the basis of the context, which of the first request and the second request should be preferentially processed.

According to the present disclosure, there is provided a program causing a computer to function as the information processing apparatus including the detection unit that detects a context associated with the user, and the request processing unit that determines, on the basis of the context, which of the first request and the second request should be preferentially processed.

### Effects of the Invention

As described above, according to the present disclosure, a technique capable of more appropriately determining a request to be preferentially processed is provided. Note that the effect described above is not necessarily limited, and any of the effects described in the present specification or another effect that can be understood from the present specification may be exerted in addition to the effect described above or instead of the effect described above.

### BRIEF DESCRIPTION OF DRAWINGS

FIG. 1 is a diagram illustrating an exemplary configuration of an information processing system according to a first embodiment.

FIG. 2 is a diagram illustrating an exemplary functional configuration of an agent.

FIG. 3 is a diagram illustrating an exemplary detailed configuration of a control unit.

FIG. 4 is a block diagram illustrating an exemplary functional configuration of a server device according to the first embodiment.

FIG. 5 is a diagram illustrating exemplary context list information.

FIG. 6 is a diagram illustrating an exemplary configuration of relevant information in which a context, attribute information, and a priority score are associated with each other.

FIG. 7 is a diagram illustrating an exemplary request queue table.

FIG. 8 is a diagram illustrating an exemplary screen presented to a user in a case where interruption has occurred.

FIG. 9 is a diagram illustrating an exemplary voice message presented to the user in a case where interruption has occurred.

FIG. 10 is a diagram for illustrating an example of priority score calculation of a request in a case where a plurality of contexts has been detected and an attribute type is single.

FIG. 11 is a diagram for illustrating an example of the priority score calculation of the request in a case where a plurality of contexts has been detected and the attribute type is plural.

FIG. 12 is a diagram for illustrating an example of diverting relevant information of another user.

FIG. 13 is a diagram illustrating exemplary relevant information in which a certainty factor based on feedback from the user is further associated.

FIG. 14 is a flowchart illustrating exemplary operation of extracting and processing a request in succession from a request queue.

FIG. 15 is a flowchart illustrating exemplary operation in a case where a new request is input while a request in processing exists.

FIG. 16 is a diagram illustrating an exemplary configuration of an information processing system according to a second embodiment.

FIG. 17 is a diagram illustrating an exemplary detailed configuration of a control unit.

FIG. 18 is a diagram illustrating an exemplary functional configuration of a server device according to the second embodiment.

FIG. 19 is a diagram illustrating an exemplary task status table.

FIG. 20 is a flowchart illustrating exemplary operation of determining whether or not a request is to be executed in an agent.

FIG. 21 is a flowchart illustrating exemplary operation of determining whether or not the request is to be executed in the server device.

FIG. 22 is a flowchart illustrating another exemplary operation of selecting an agent to execute the request in the server device.

FIG. 23 is a diagram illustrating an exemplary configuration of an information processing system according to a third embodiment.

FIG. 24 is a diagram illustrating an exemplary detailed configuration of a control unit.

FIG. 25 is a flowchart illustrating exemplary operation of determining whether or not a request is to be executed in an agent (slave device).

FIG. 26 is a flowchart illustrating exemplary operation of selecting an agent to execute the request in the agent (master device).

FIG. 27 is a flowchart illustrating another exemplary operation of selecting the agent to execute the request in the agent (master device).

FIG. 28 is a diagram illustrating an exemplary configuration of an information processing system according to a fourth embodiment.

FIG. 29 is a diagram illustrating an exemplary detailed configuration of a control unit.

FIG. 30 is a diagram illustrating an exemplary correspondence relationship between each condition and a presentation mode.

FIG. 31 is a diagram illustrating an exemplary correspondence relationship between each condition for each user and the presentation mode.

FIG. 32 is another diagram illustrating an exemplary correspondence relationship between each condition for each user and the presentation mode.

FIG. 33 is a diagram illustrating exemplary presentation in an audio-based presentation mode.

FIG. 34 is a diagram illustrating exemplary presentation in an audio video presentation mode.

FIG. 35 is another diagram illustrating exemplary presentation in the audio video presentation mode.

FIG. 36 is a diagram illustrating another exemplary presentation in the audio-based presentation mode.

FIG. 37 is a diagram illustrating another exemplary presentation in the audio video presentation mode.

FIG. 38 is a diagram illustrating still another exemplary presentation in the audio video presentation mode.

FIG. 39 is a flowchart illustrating exemplary operation of presenting presentation information to the user in response to a request input by the user.

FIG. 40 is a diagram illustrating a first variation of a display unit and the screen.

FIG. 41 is a diagram illustrating a second variation of the display unit and the screen.

FIG. 42 is a diagram illustrating a third variation of the display unit and the screen.

FIG. 43 is a diagram illustrating a fourth variation of the display unit and the screen.

FIG. 44 is a diagram illustrating a fifth variation of the display unit and the screen.

FIG. 45 is a diagram illustrating exemplary presentation of the presentation information in consideration of a situation of a plurality of users.

FIG. 46 is a block diagram illustrating an exemplary hardware configuration of an information processing apparatus.

### MODE FOR CARRYING OUT THE INVENTION

Hereinafter, preferred embodiments of the present disclosure will be described in detail with reference to the accompanying drawings. Note that, in the present specification and the drawings, constituent elements having substantially the same functional configuration will be denoted by the same reference signs, and duplicate descriptions thereof will be omitted.

Furthermore, in the present specification and the drawings, a plurality of constituent elements having substantially the same or similar functional configuration may be distinguished by different numerals being attached after the same reference signs. However, in a case where each of the plurality of constituent elements having substantially the same or similar functional configuration is not particularly required to be distinguished, only the same reference sign is given. Furthermore, similar constituent elements of different embodiments may be distinguished by different alphabets being attached after the same reference signs. However, in a case where each of the similar constitution elements is not particularly required to be distinguished, only the same reference sign is given.

Note that descriptions will be given in the following order.

0. Overview (Request to be preferentially processed)

1. First Embodiment

1.1. Exemplary system configuration

1.2. Exemplary functional configuration of agent

1.3. Exemplary functional configuration of server device

1.4. Functional detail of information processing system

1.5. Exemplary operation

2. Second Embodiment

2.1. Exemplary system configuration

2.2. Exemplary functional configuration of agent

2.3. Exemplary functional configuration of server device

2.4. Functional detail of information processing system

2.5. Exemplary operation

3. Third Embodiment

3.1. Exemplary system configuration

3.2. Exemplary functional configuration of master device

3.3. Exemplary operation

4. Overview (Control of presentation information to user)

5. Fourth Embodiment

5.1. Exemplary system configuration

5.2. Exemplary functional configuration of agent

5.3. Functional detail of information processing system

5.4. Exemplary operation

5.5. Autonomous presentation from agent

5.6. Variation of display unit and screen

5.7. Exemplary presentation corresponding to multiple users

6. Exemplary hardware configuration

7. Conclusion

<0. Overview (Request to be Preferentially Processed)>

First, an overview of a technique of determining a request to be preferentially processed will be described. In recent years, various techniques have been known as a technique of processing a request from a user. For example, there has been disclosed a technique of determining, in a case where a new request is input in addition to a request in processing, whether or not to allow the new request to perform interruption depending on whether or not the interruption is permitted.

In addition, there has also been known a technique of determining a request to be preferentially processed on the basis of a priority score associated with the request. Such a priority score is manually registered by the user in advance in an initial setting or the like. However, in a case where the priority score registered in advance does not change, it is difficult to more appropriately determine the request to be preferentially processed.

To give description with a specific example, it is assumed that a child and a mother have been using an agent before the start of work in the morning. At this time, it is assumed that a father has inquired a traffic report to the agent. In such a situation, while the priority score of the request input by the father should be set high, in a case where the priority score of the father is not set high, the request from the father may be ignored or postponed at times.

In view of the above, in the present specification, a technique capable of more appropriately determining the request to be preferentially processed will be mainly described.

In the foregoing, the overview of the technique of determining the request to be preferentially processed has been described.

### 1. First Embodiment

First, a first embodiment will be described.

[1.1. Exemplary System Configuration]

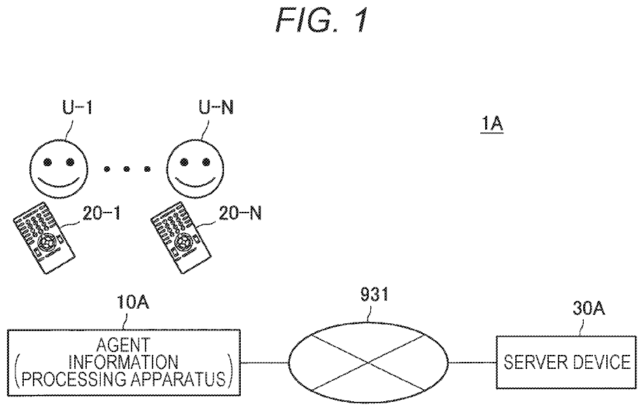

First, an exemplary configuration of an information processing system according to the first embodiment will be described with reference to the drawings. FIG. 1 is a diagram illustrating the exemplary configuration of the information processing system according to the first embodiment. As illustrated in FIG. 1, an information processing system 1A according to the first embodiment includes an information processing apparatus 10A, controllers 20-1 to 20-N(N is a natural number), and a server device 30A. The information processing apparatus 10A and the server device 30A are capable of performing communication via a communication network 931.

Furthermore, in the present specification, a case where the information processing apparatus 10A is an agent that controls execution of processing of a request (e.g., first request and second request to be described below) on behalf of users U-1 to U-N will be mainly described. Accordingly, the information processing apparatus 10A will be mainly referred to as an “agent” in the following descriptions. The information processing apparatus 10A is capable of processing a request input by the users U-1 to U-N. However, the information processing apparatus 10A is not limited to an agent.

In the present specification, a case where each of the users U-1 to U-N can use a controller 20 individually will be mainly described. However, a part of or all of the users U-1 to U-N may be capable of using a plurality of controllers 20, or may not be capable of using any of the controllers 20. Upon reception of input operation from the user U, the controller 20 transmits a request corresponding to the operation to the agent 10A. The controller 20 may be a remote controller, or may be a smartphone.

Furthermore, each of the users U-1 to U-N is capable of inputting a request to the agent 10 by utterance. Note that voice/speech and sound are distinguished from each other and used in the following descriptions. For example, the voice/speech may mainly indicate utterance of the user among the sounds collected by the agent 10, and the sound may include noise and the like in addition to the utterance of the user.

Furthermore, the server device 30A is assumed to be a computer such as a server device. The server device 30A manages the agent 10A. Note that a case where there is one agent 10A is mainly assumed in the first embodiment. However, there may be a plurality of agents 10A in the first embodiment in a similar manner to a second and subsequent embodiments. In such a case, the server device 30A can manage the plurality of agents 10A.

The exemplary configuration of the information processing system 1A according to the first embodiment has been described as above.

[1.2. Exemplary Functional Configuration of Agent]

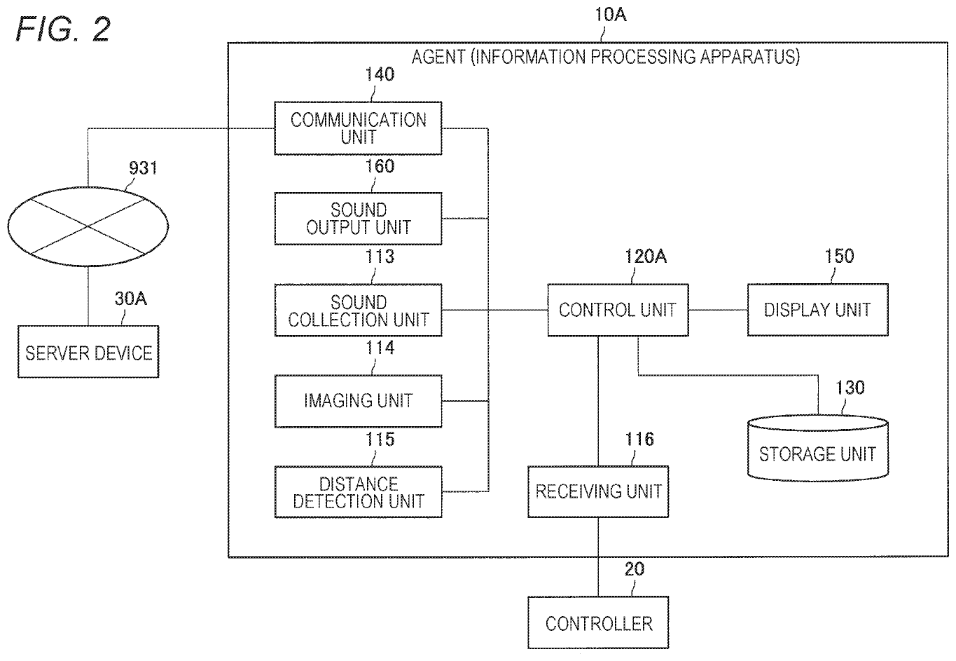

Next, an exemplary functional configuration of the agent 10A will be described. FIG. 2 is a diagram illustrating the exemplary functional configuration of the agent 10A. As illustrated in FIG. 2, the agent 10A includes a sound collection unit 113, an imaging unit 114, a distance detection unit 115, a receiving unit 116, a control unit 120A, a storage unit 130, a communication unit 140, a display unit 150, and a sound output unit 160. The agent 10A and the controller 20 are capable of performing communication via a network (e.g., wireless local area network (LAN), etc.). Furthermore, the agent 10A is connected to the server device 30A via the communication network 931. The communication network 931 includes, for example, the Internet.

The sound collection unit 113 has a function of obtaining sound by sound collection. For example, the sound collection unit 113 includes a microphone, and collects sounds using the microphone. The number of microphones included in the sound collection unit 113 is not particularly limited as long as it is one or more. In addition, a position at which each of one or more microphones included in the sound collection unit 113 is provided is also not particularly limited. Note that the sound collection unit 113 may include a sound collection device in a form other than the microphone as long as it has a function of collecting sound information.

The imaging unit 114 has a function of inputting an image by imaging. For example, the imaging unit 114 includes a camera (including an image sensor), and inputs an image captured by the camera. A type of the camera is not limited. For example, the camera may be a wide-angle camera, a depth camera, or a camera that obtains an image capable of detecting a line of sight of the user U. The number of cameras included in the imaging unit 114 is not particularly limited as long as it is one or more. In addition, a position at which each of one or more cameras included in the imaging unit 114 is provided is also not particularly limited. Furthermore, one or more cameras may include a monocular camera, or may include a stereo camera.

The distance detection unit 115 has a function of detecting a distance to the user U. For example, the distance detection unit 115 includes a distance measuring sensor, and obtains the distance to the user U detected by the distance measuring sensor. A position at which the distance measuring sensor is provided is not particularly limited. Furthermore, a type of the distance measuring sensor is not particularly limited. For example, the distance measuring sensor may be an infrared distance sensor, or may be an ultrasonic distance sensor. Alternatively, the distance detection unit 115 may detect the distance on the basis of the magnitude of the voice of the user U collected by the sound collection unit 113, or may detect the distance on the basis of the size of the user U appearing in the image captured by the imaging unit 114.

The receiving unit 116 includes a communication circuit, and receives a request transmitted from the controller 20. Note that the receiving unit 116 corresponds to a type of a wireless signal transmitted from the controller 20. In other words, in a case where the type of the wireless signal transmitted from the controller 20 is a radio wave, the radio wave can be received. Alternatively, in a case where the type of the wireless signal transmitted from the controller 20 is infrared rays, the infrared rays can be received.

The communication unit 140 includes a communication circuit, and has a function of obtaining data from the server device 30A connected to the communication network 931 via the communication network 931 and providing data to the server device 30A. For example, the communication unit 140 includes a communication interface. Note that the number of the server device 30A to be connected to the communication network 931 may be one or may be plural.

The storage unit 130 includes a memory, and is a recording medium that stores a program to be executed by the control unit 120A and stores data necessary for execution of the program. Furthermore, the storage unit 130 temporarily stores data for computing performed by the control unit 120A. The storage unit 130 includes a magnetic storage unit device, a semiconductor storage device, an optical storage device, a magneto-optical device, or the like.

The display unit 150 has a function of displaying various screens. Although the case where the display unit 150 is a projector (e.g., single focus projector) is mainly assumed in the present specification, a type of the display unit 150 is not limited. For example, the display unit 150 may be a liquid crystal display, or may be an organic electro-luminescence (EL) display, as long as it is a display capable of performing display that can be visually recognized by the user. Furthermore, although the case where the display unit 150 performs display on a relatively high position (e.g., wall surface, etc.) or performs display on a relatively low position (e.g., agent's stomach, user's hand, etc.) is mainly assumed in the present specification, the position at which the display unit 150 performs display is also not limited.

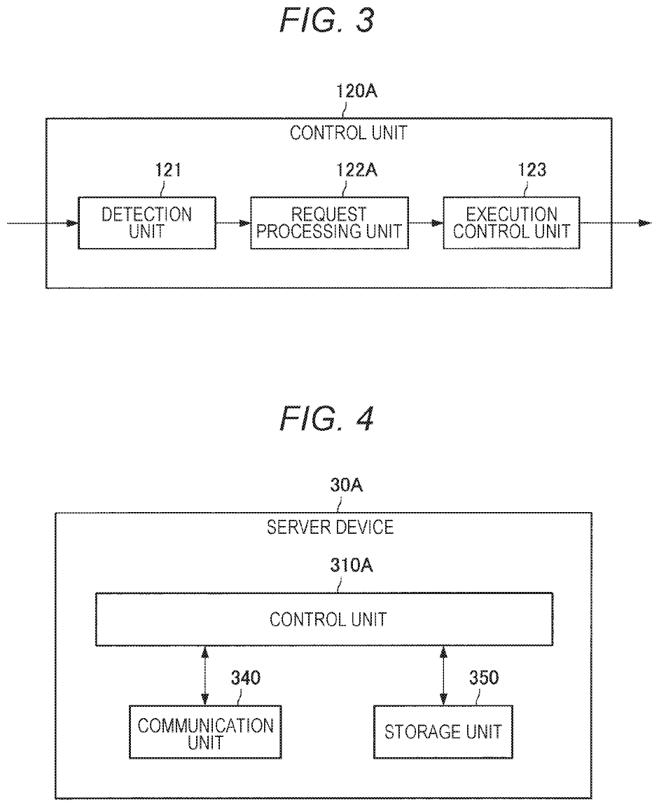

The control unit 120A executes control of each unit of the agent 10A. FIG. 3 is a diagram illustrating an exemplary detailed configuration of the control unit 120A. As illustrated in FIG. 3, the control unit 120A includes a detection unit 121, a request processing unit 122A, and an execution control unit 123. Details of each of those functional blocks will be described later. Note that the control unit 120A may include, for example, one or a plurality of central processing units (CPUs), or the like. In a case where the control unit 120A includes a processing device such as the CPU, the processing device may include an electronic circuit.

Returning to FIG. 2, the description will be continued. The sound output unit 160 has a function of outputting sound. For example, the sound output unit 160 includes a speaker, and outputs sound using the speaker. The number of speakers included in the sound output unit 160 is not particularly limited as long as it is one or more. In addition, a position at which each of one or more speakers included in the sound output unit 160 is provided is also not particularly limited. Note that the sound output unit 160 may include a sound output device in a form other than the speaker (e.g., earphone, headset, etc.) as long as it has the function of outputting sound.

The exemplary functional configuration of the agent 10A according to the first embodiment has been described as above.

[1.3. Exemplary Functional Configuration of Server Device]

Next, an exemplary functional configuration of the server device 30A according to the first embodiment will be described. FIG. 4 is a block diagram illustrating the exemplary functional configuration of the server device 30A according to the first embodiment. As illustrated in FIG. 4, the server device 30A includes a control unit 310A, a communication unit 340, and a storage unit 350. Hereinafter, those functional blocks of the server device 30A will be described.

The control unit 310A executes control of each unit of the server device 30A. Note that the control unit 310A may include, for example, a processing device such as one or a plurality of central processing units (CPUs). In a case where the control unit 310A includes a processing device such as the CPU, the processing device may include an electronic circuit.

The communication unit 340 includes a communication circuit, and has a function of communicating with another device via the network 931 (FIG. 1). For example, the communication unit 340 includes a communication interface. For example, the communication unit 340 is capable of communicating with the agent 10A via the network 931 (FIG. 1).

The storage unit 350 includes a memory, and is a recording device that stores a program to be executed by the control unit 310A and stores data necessary for execution of the program. Furthermore, the storage unit 350 temporarily stores data for computing performed by the control unit 310A. Note that the storage unit 350 may be a magnetic storage unit device, a semiconductor storage device, an optical storage device, or a magneto-optical storage device.

The exemplary functional configuration of the server device 30A according to the first embodiment has been described as above.

[1.4. Functional Detail of Information Processing System] Next, functional details of the information processing system 1A according to the first embodiment will be described. In the first embodiment, the detection unit 121 detects a context associated with the user. Then, the request processing unit 122A determines which of a first request and a second request should be preferentially processed on the basis of the context detected by the detection unit 121. According to such a configuration, it becomes possible to more appropriately determine a request to be preferentially processed.

The context associated with the user is not particularly limited. For example, the context associated with the user may include at least one of time information associated with the user, weather information associated with the user,

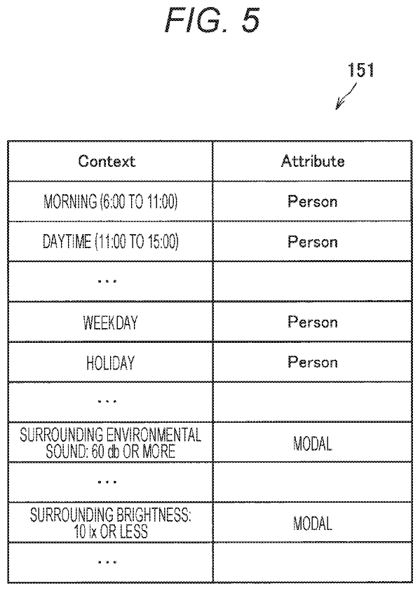

environmental information associated with the user, or content of utterance associated with the user. FIG. 5 is a diagram illustrating exemplary context list information. Referring to FIG. 5, context list information 151 is illustrated, and an exemplary context associated with the user is illustrated.

Here, the time information associated with the user may be time information to which the current time at which the user is present belongs. The time information may be information indicating a time zone (e.g., 6 am to 11 am, morning, daytime, etc.), or may be information indicating a day of the week (e.g., weekday, holiday, Monday, Sunday, etc.). The current time may be obtained from a clock existing in the agent 10A or in a device outside the agent 10A (e.g., server device 30A, etc.). Furthermore, the time information associated with the user may be appropriately obtained from the inside of the agent 10A or a device outside the agent 10A (e.g., server device 30A, etc.).

The weather information associated with the user may be weather information regarding a location at which the user is present. The weather information may be information indicating weather (e.g., sunny, cloudy, rainy, etc.). The location at which the user is present may be obtained by some sort of positioning function, or may be set in advance by the user. Furthermore, the weather information associated with the user may be appropriately obtained from the inside of the agent 10A or a device outside the agent 10A (e.g., server device 30A, etc.).

The environmental information associated with the user may be information indicating the surrounding environment of the location at which the user is present. The environmental information may be information indicating brightness (e.g., surrounding brightness of 10 lx or less, etc.), or may be information indicating a sound volume (e.g., surrounding environmental sound of 60 db or more, etc.). If the agent 10A includes a light sensor, the information indicating brightness can be detected by the light sensor. Furthermore, if the agent 10A includes a sound sensor, the information indicating a sound volume may be detected by the sound sensor.

The content of utterance associated with the user may be obtained by voice recognition for the sound information detected by the sound collection unit 113. The voice recognition may be performed by the agent 10A, or may be performed by a device outside the agent 10A (e.g., server device 30A, etc.). Furthermore, the content of utterance associated with the user may be text data itself obtained by the voice recognition, or may be a keyword recognized from the text data obtained by the voice recognition.

More specifically, the request processing unit 122A may determine which of the first request and the second request should be preferentially processed on the basis of comparison between the priority score of the first request and the priority score of the second request. For example, the request processing unit 122A may determine that, among the priority score of the first request and the priority score of the second request, the request having a higher priority score should be preferentially processed.

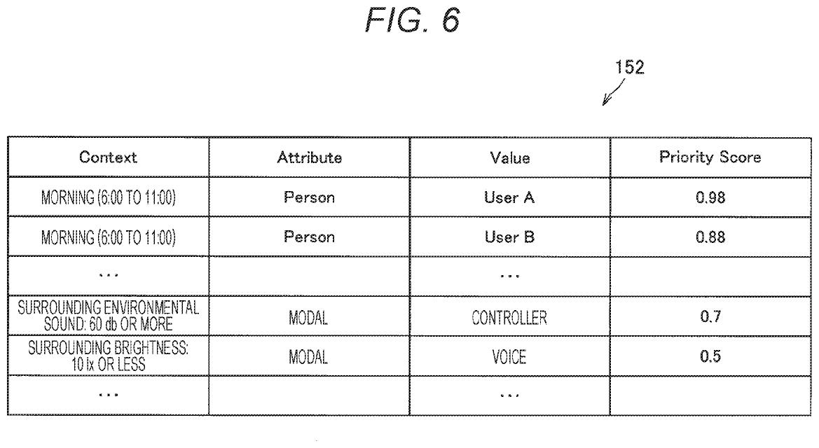

The priority score of the first request and the priority score of the second request may be determined in any way. FIG. 6 is a diagram illustrating an exemplary configuration of relevant information in which the context, attribute information, and the priority score are associated with each other. As illustrated in FIG. 6, relevant information 152 includes the context, the attribute information (combination of an attribute type “attribute” and an attribute value “value” in the example illustrated in FIG. 6), and the priority score (“priority score” in the example illustrated in FIG. 6), which are associated with each other.

Such relevant information 152 may be appropriately obtained from the inside of the agent 10A or a device outside the agent 10A (e.g., server device 30A, etc.) by the request processing unit 122A. For example, the request processing unit 122A may obtain the priority score of the first request on the basis of the attribute information of the first request and the context detected by the detection unit 121, and may obtain the priority score of the second request on the basis of the attribute information of the second request and the context.

Here, the attribute information of each of the first request and the second request may include an attribute type and an attribute value corresponding to the attribute type. At this time, for example, the request processing unit 122A may obtain the attribute information (combination of the attribute type and the attribute value) of each of the first request and the second request, and may obtain, from the relevant information 152, the priority score corresponding to the attribute information (combination of the attribute type and the attribute value) of each of the first request and the second request and the context detected by the detection unit 121.

The attribute type may include information indicating the user (“person” in the example illustrated in FIG. 6), or information indicating a device (“modal” illustrated in FIG. 6). Furthermore, in the example illustrated in FIG. 6, “user A (father)” and “user B (utterer)” are indicated as attribute values corresponding to the attribute type “Person”. Furthermore, “controller” and “voice” are indicated as attribute values corresponding to the attribute type “modal”.

As an example, in a case where the context is “weekday morning”, it is considered that the request from the father before going to work should be prioritized. Accordingly, in the relevant information 152, the attribute type “person” and the attribute value “user A (father)” are preferably associated with the context “weekday morning”.

As another example, in a case where the context is “surrounding brightness of 10 lx or less”, it is considered that the request based on the modal “voice” should be prioritized due to the circumstance that the controller tends to be operated erroneously. Accordingly, in the relevant information 152, the attribute type “modal” and the attribute value “voice” are preferably associated with the context “surrounding brightness of 10 lx or less”.

To the contrary, in a case where the context is “surrounding environmental sound of 60 db or more”, it is considered that the request based on the modal “controller” should be prioritized due to the circumstance that the voice tends to be recognized erroneously. Accordingly, in the relevant information 152, the attribute type “modal” and the attribute value “controller” are preferably associated with the context “surrounding environmental sound of 60 db or more”.

As another example, in a case where the context is “the keyword “help” is included in the text data obtained by the voice recognition”, it is considered that the request from the utterer of the keyword “user B (utterer)” should be prioritized. Accordingly, in the relevant information 152, the attribute type “person” and the attribute value “user B (utterer)” are preferably associated with the context “the keyword “help” is included in the text data obtained by the voice recognition”.

As another example, in a case where the context is “the weather is rainy”, it is considered that the request based on the modal “voice” should be prioritized due to the circumstance that the surroundings tend to be dark. Accordingly, in the relevant information 152, the attribute type “modal” and the attribute value “voice” are preferably associated with the context “the weather is rainy”.

In addition, in a case where the context is “the line of sight of a certain user is oriented toward the agent”, “a certain user is opening his/her eyes wide (absolutely or relative to a standard eye size of the user)”, “the utterance sound volume of a certain user is increasing”, “the voice of a certain user is treble”, or “the expression of a certain user is serious”, it is considered that the requests from those users should be prioritized. Accordingly, in the relevant information 152, the attribute type “person” and those users are preferably associated with those contexts.

Note that, in a case where the attribute type of the request includes “person”, the attribute value “user A” or the like corresponding to the attribute type “person” of the request may be recognized in any way. For example, in a case where the attribute type includes “person”, the request processing unit 122A may obtain the attribute value recognized on the basis of a result of the voice recognition. Alternatively, the request processing unit 122A may obtain the attribute value recognized on the basis of a result of face recognition. At this time, the voice and the face image used for the recognition may be registered in advance. Furthermore, in a case where voice or a face of an unregistered user is recognized, the user may be newly registered.

Hereinafter, description will be given with a request in processing being described as an example of the first request, and with a newly input request being described as an example of the second request. However, the first request is not limited to the request in processing. Furthermore, the second request is not limited to the newly input request. For example, at least one of the first request or the second request may be a request that has not been processed (it may be a request existing in a request queue).

The request newly input to the agent 10A is added to the request queue unless interruption occurs on the request in processing. Furthermore, the request processing unit 122A can extract and process the request having the highest priority score in succession from the request queue. The requests existing in the request queue are managed inside the agent 10A as a request queue table.

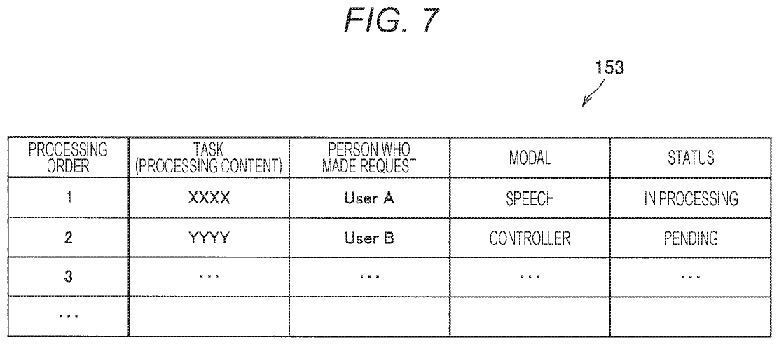

FIG. 7 is a diagram illustrating an example of the request queue table. As illustrated in FIG. 7, a processing order of the request, a task corresponding to the request, the user who has made the request, the modal, and a status are associated with each other in a request queue table 153. As illustrated in FIG. 7, the request with the status “in processing” is the request having the highest priority score, which is the request extracted from a message queue and currently in processing. Furthermore, the request with the status “pending” is a request existing in the message queue.

Here, the request processing unit 122A compares the priority scores of each of the request in processing and the newly input request, and in a case where it determines that the request in processing should be preferentially processed, it continues to process the request in processing.

On the other hand, in a case where the execution control unit 123 compares the priority scores of each of the request in processing and the newly input request and determines that the newly input request should be preferentially processed, the newly input request may interrupt the request in processing. In a case where such interruption has occurred, the execution control unit 123 may control output of predetermined output information. The output information may be presented to the user who has made the request in processing, or may be presented to the user who has made the newly input request.

Here, a type of the output information is not limited. For example, the output information may be visually presented. The visual presentation may be presented to the agent 10A by a predetermined gesture (e.g., gesture of directing a palm toward the user who has made the request to be interrupted, etc.), or may be presented with hardware such as light emission of a lamp (e.g., light emission of a red lamp, etc.). Alternatively, the output information may be the presentation of the request queue table 153 itself managed by the agent 10A.

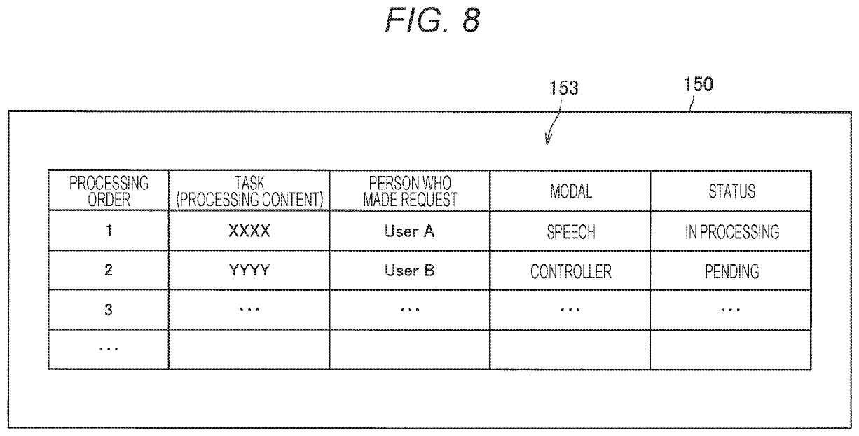

FIG. 8 is a diagram illustrating an exemplary screen presented to the user in a case where interruption has occurred. As illustrated in FIG. 8, the execution control unit 123 may control the display unit 150 such that the request queue table 153 is presented by the display unit 150. At this time, in order to make it easy to discriminate between the request that has performed interruption and the request that has been interrupted, the execution control unit 123 may add a predetermined animation (e.g., blinking, etc.) to, among the request queue table 153, each row of the request that has performed interruption and the request that has been interrupted.

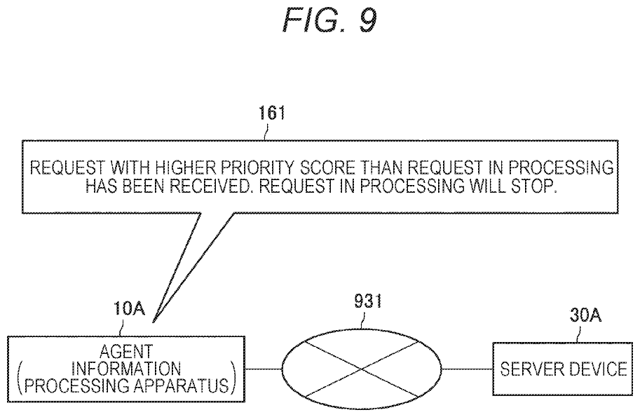

Alternatively, the output information may be presented by voice. FIG. 9 is a diagram illustrating an exemplary voice message presented to the user in a case where interruption has occurred. As illustrated in FIG. 9, the execution control unit 123 may control output of a predetermined voice message 161 (in the example illustrated in FIG. 9, the voice message “A request with a priority score higher than that of the request in processing has been received, so the request in processing will stop.”). However, the voice message 161 is not particularly limited.

In the foregoing description, the case where the detection unit 121 detects one context has been mainly described. However, there may be a case where the detection unit 121 detects a plurality of contexts. For example, it is assumed a case where the detection unit 121 detects a first context and a second context and the attribute types corresponding to the first context and the second context are the same. In such a case, the request processing unit 122A may obtain the priority score of each of the first request and the second request on the basis of computing of priority scores associated with the same attribute information corresponding to each of the first context and the second context.

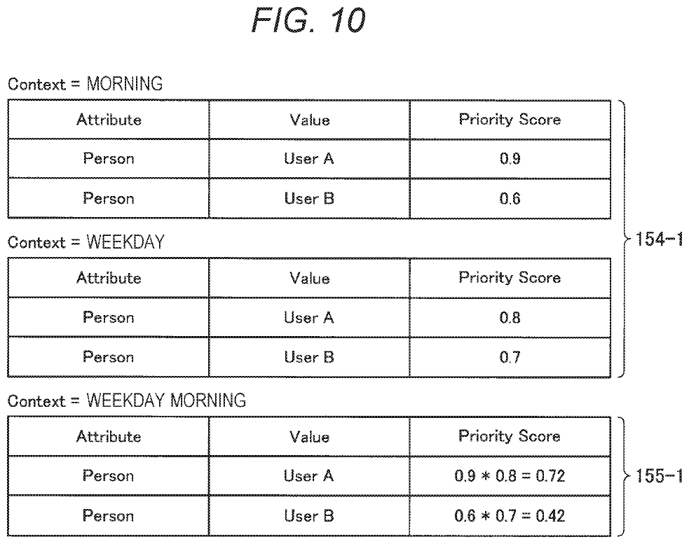

FIG. 10 is a diagram for illustrating an example of priority score calculation of the request in a case where a plurality of contexts has been detected and the attribute type is single. In the example illustrated in FIG. 10, it is assumed a case where the context “morning” and the context “weekday” have been detected.

A correspondence table 154-1 includes various kinds of information corresponding to the context “morning” (attribute type, attribute value, and priority score), and various kinds of information corresponding to the context “weekday”. At this time, as illustrated in a correspondence table 155-1, by multiplication of the priority scores “0.9” and “0.8” associated with the same attribute information (e.g., attribute type “person” and attribute value “user A”), the priority score of the request having this attribute information may be calculated as “0.72”. Note that the computing of the priority scores is not limited to the multiplication of the priority scores, but may be addition of the priority scores, or may be the average value of the priority scores.

Furthermore, it is also assumed a case where the detection unit 121 detects the first context and the second context and the attribute types corresponding to the first context and the second context are different. In such a case, the request processing unit 122A may obtain the priority score of each of the first request and the second request on the basis of computing of priority scores associated with different attribute information corresponding to each of the first context and the second context.

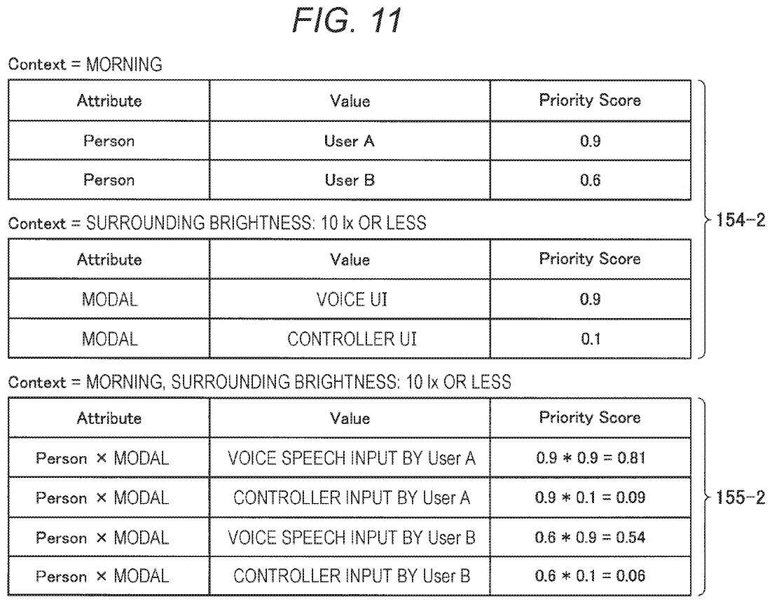

FIG. 11 is a diagram for illustrating an example of the priority score calculation of the request in a case where a plurality of contexts has been detected and the attribute type is plural. In the example illustrated in FIG. 11, it is assumed a case where the context “morning” and the context “surrounding brightness of 10 lx or less” have been detected.

A correspondence table 154-2 includes various kinds of information corresponding to the context “morning” (attribute type, attribute value, and priority score), and various kinds of information corresponding to the context “surrounding brightness of 10 lx or less”. At this time, as illustrated in a correspondence table 155-2, by multiplication of the priority scores “0.9” and “0.9” associated with the different attribute information (e.g., attribute type “person” and attribute value “user A”, and the attribute type “modal” and the attribute value “voice UI”), the priority score of the request having those attribute information may be calculated as “0.81”. Note that the computing of the priority scores is not limited to the multiplication of the priority scores, but may be addition of the priority scores, or may be the average value of the priority scores.

In the foregoing description, the example of the context has been described. The context may include a relationship between a certain parameter and a threshold value. For example, the context “surrounding environmental sound of 60 db or more” includes a relationship between a parameter “surrounding environmental sound” and a threshold value “60 db”. Such a threshold value may be set by the user in advance, or may be dynamically changed. For example, it is considered that an optimal threshold value of the surrounding environmental sound or the like can change depending on the location of the agent 10A, whereby the threshold value is preferably changed dynamically.

Specifically, in the environment in which the agent 10A is placed, the sound collection unit 113 may continue to detect surrounding environmental sound for a predetermined period of time. Then, the request processing unit 122A may set, with the average value of the surrounding environmental sound detected in the predetermined period of time being set as a reference, a value deviated by x % from the reference to be a threshold value (abnormal value).

In the foregoing description, the example of the relevant information 152 in which the attribute information and the priority score are associated with each other has been described (FIG. 6). Such relevant information 152 may be set in any way. For example, the relevant information 152 may be set by a product (service) provider of the agent 10A before provision of the product (service). Alternatively, the relevant information 152 may be set by the user. However, it is also assumed that the relevant information 152 sets the relevant information 152 to be more suitable for the environment in which the agent 10A is placed and for the user of the agent 10A.

Specifically, it is assumed a case where the relevant information of another user is also managed in the server device 30A. Accordingly, the request processing unit 122A may obtain, as the relevant information 152, the relevant information of the other user having a predetermined analogous relationship with the user of the agent 10A. The predetermined analogous relationship is not particularly limited.

For example, the predetermined analogous relationship may be a relationship in which a degree of similarity between the information associated with the user of the agent 10A and the information associated with the other user exceeds a threshold value, or may be a relationship in which the information associated with the other user is most similar to the information associated with the user of the agent 10A. The degree of similarity between the information associated with the user of the agent 10A and the information associated with the other user is not particularly limited, but may be a cosine degree of similarity or the like.

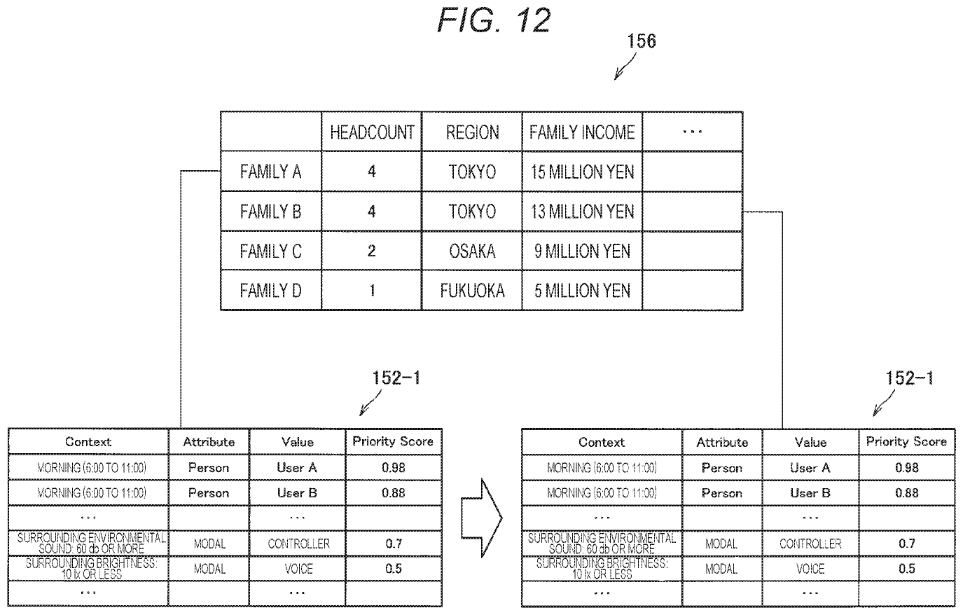

FIG. 12 is a diagram for illustrating an example of diverting the relevant information of the other user. As illustrated in FIG. 12, the storage unit 350 stores information 156 associated with a plurality of users in the server device 30A. In the example illustrated in FIG. 12, the other user is assumed to be a “family member A”. Furthermore, the user of the agent 10A is assumed to be a “family member B”. At this time, the control unit 310A refers to the information 156 associated with the plurality of users, and determines that the information associated with the other user “family member A” and the information associated with the user “family member B” of the agent 10A have a predetermined analogous relationship.

Accordingly, as illustrated in FIG. 12, the communication unit 340 may transmit relevant information 152-1 of the other user “family member A” to the agent 10A as relevant information of the user “family member B” of the agent 10A. At this time, in the agent 10A, the communication unit 140 may receive the relevant information 152-1 of the other user “family member A”, and the request processing unit 122A may determine the priority score of the request on the basis of the relevant information 152-1 of the other user “family member A”.

Furthermore, a certainty factor based on feedback from the user may be associated with the relevant information (e.g., relevant information 152-1 of the other user “family member A”) of the agent 10A, and it may be determined whether or not to be adopted on the basis of the certainty factor. More specifically, the request processing unit 122A associates the certainty factor based on feedback from the user with the relevant information of the agent 10A. Then, in a case where the certainty factor associated with at least one of the attribute information of each of the first request or the second request is lower than a predetermined threshold value, the request processing unit 122A is not required to determine which of the first request and the second request should be preferentially processed.

Here, the predetermined threshold value may be a pseudo random number. For example, the certainty factor can take the range of 0≤certainty factor≤1. Furthermore, an initial value of the certainty factor may be set as an optional value in the range of 0 to 1 (e.g., 0.5, etc.).

Then, in a case where the detection unit 121 detects positive feedback from the user, the request processing unit 122A may set “+1” as a reward. Furthermore, in a case where the detection unit 121 detects negative feedback from the user, the request processing unit 122A may set “0” as a reward. Furthermore, in a case where the detection unit 121 detects different feedback from the plurality of users, the request processing unit 122A may treat the feedback as negative feedback if there is any user who made negative feedback.

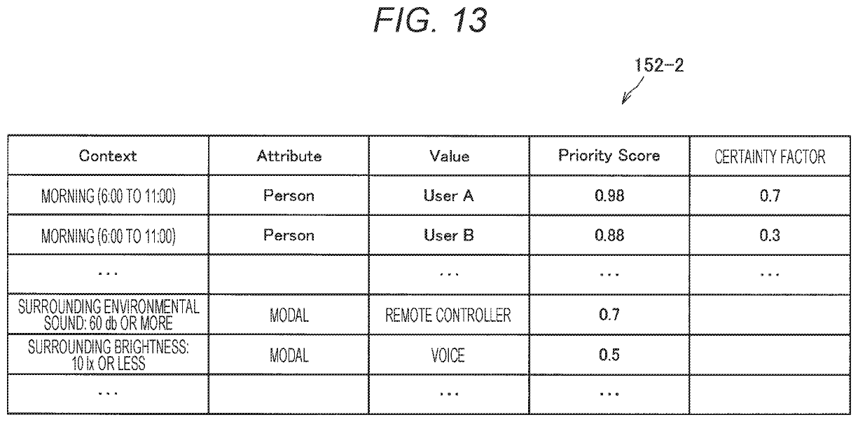

The certainty factor may be calculated by the request processing unit 122A on the basis of the total reward value/total number of trials. FIG. 13 is a diagram illustrating exemplary relevant information 152-2 in which the certainty factor based on feedback from the user is further associated.

For example, the positive feedback may be a UI operation indicating a positive (e.g., pressing of a button indicating a positive, etc.), may be a predetermined voice indicating appreciation (e.g., message such as “thank you”) (from the user who has performed interruption), or may be implicit behavior similar to that (e.g., behavior of expressing a predetermined expression such as a smile, etc.).

For example, the negative feedback may be a UI operation indicating a negative (e.g., pressing of a button indicating a negative, etc.), may be a predetermined voice indicating repulsion (expressed by the user who has been interrupted) (e.g., message such as “do not interrupt”), or may be implicit behavior similar to that (e.g., behavior of expressing a displeased expression, etc.).

Moreover, there may be a case where a new user (e.g., unregistered user, etc.) makes a request. For example, it is assumed a case where, while only a father, a mother, and a child use the agent 10A normally, a grandmother who lives far has come to their house. In such a case, the request processing unit 122A may obtain, as the priority score of the new user, the priority score of another user having a predetermined analogous relationship with the new user. As described above, the predetermined analogous relationship is not particularly limited.

The functional details of the information processing system 1A according to the first embodiment have been described as above.

[1.5. Exemplary Operation]

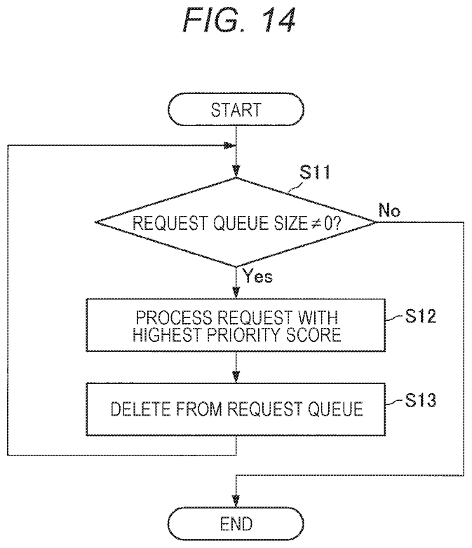

Next, exemplary operation of the information processing system 1A according to the first embodiment will be described. FIG. 14 is a flowchart illustrating exemplary operation of extracting and processing a request in succession from the request queue. As illustrated in FIG. 14, in a case where the request queue size is “0” (“No” in S11), the request processing unit 122A terminates the operation.

On the other hand, in a case where the request queue size exceeds “0” (“Yes” in S11), the request processing unit 122A extracts the request having the highest priority score, and processes the extracted request (S12). After processing the request, the request processing unit 122A deletes the request from the request queue (S13), and returns to S11.

FIG. 15 is a flowchart illustrating exemplary operation in a case where a new request is input while a request in processing exists. As illustrated in FIG. 15, in a case where a new request is input, the request processing unit 122A determines whether or not another request is in processing (S21). In a case where the other request is not in processing (“No” in S21), the request processing unit 122A proceeds to S26. On the other hand, in a case where the other request is in processing (“Yes” in S21), the request processing unit 122A obtains the context detected by the detection unit 121 (S22).

Subsequently, the request processing unit 122A determines whether or not the context detected by the detection unit 121 exists in the relevant information 152 (S23). In a case where the corresponding request does not exist (“No” in S23), the request processing unit 122A proceeds to S26. On the other hand, in a case where the corresponding request exists (“Yes” in S23), the request processing unit 122A obtains, from the relevant information 152, the attribute associated with the context (S24).

Subsequently, the request processing unit 122A determines whether or not the attribute value corresponding to the attribute exists in the relevant information 152 (S25). In a case where the corresponding attribute value does not exist (“No” in S25), the request processing unit 122A adds the newly input request to the request queue (S26). On the other hand, in a case where the corresponding attribute value exists (“Yes” in S25) and the certainty factor associated with the corresponding attribute value is less than the pseudo random number (rand) (“No” in S251), the request processing unit 122A adds the newly input request to the request queue (S26). On the other hand, in a case where the corresponding attribute value exists (“Yes” in S25) and the certainty factor associated with the corresponding attribute value is equal to or more than the pseudo random number (rand) (“Yes” in S251), the request processing unit 122A obtains the priority score associated with the attribute value, and determines which of the newly input request and the request in processing should be prioritized by comparing the priority scores (S27).

In a case where it is determined that the newly input request should be prioritized by comparison of priority scores (i.e., interruption has occurred in the task in processing) (“Yes” in S28), the execution control unit 123 notifies the user of the occurrence of the interruption (S29), and proceeds to S30. On the other hand, in a case where the request processing unit 122A determines that the request in processing should be prioritized by comparing the priority scores (i.e., no interruption occurs in the task in processing) (“No” in S28), it updates the request queue table (S30), and terminates the operation.

The exemplary operation of the information processing system 1A according to the first embodiment has been described as above.

In the foregoing, the first embodiment has been described.

### 2. Second Embodiment

Next, a second embodiment will be described. In the first embodiment, a case where there is one agent 10 has been mainly assumed. In the second embodiment, a case where there are a plurality of agents 10 will be mainly described.

[2.1. Exemplary System Configuration]

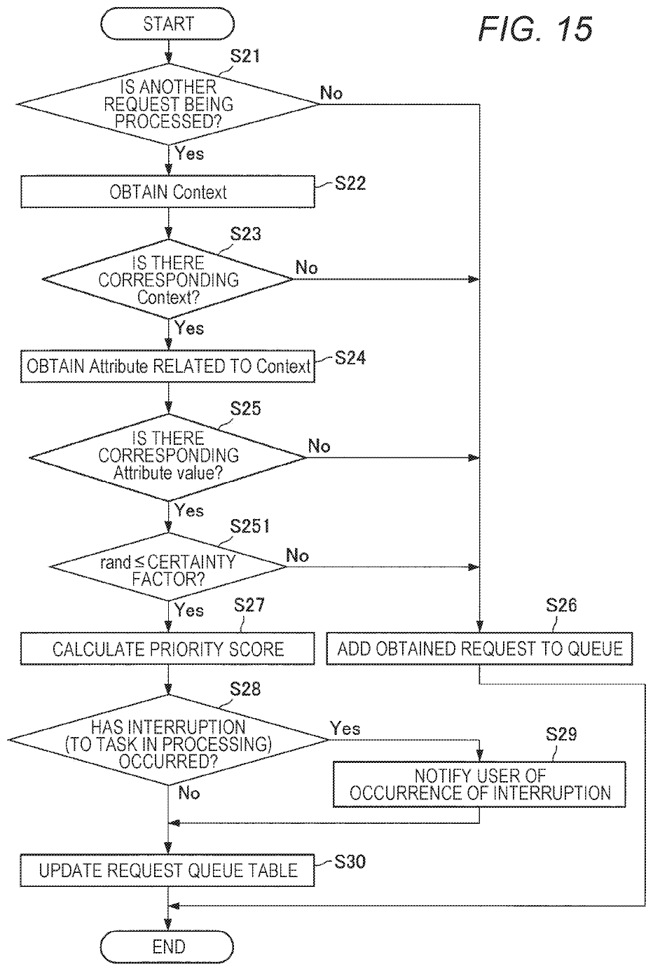

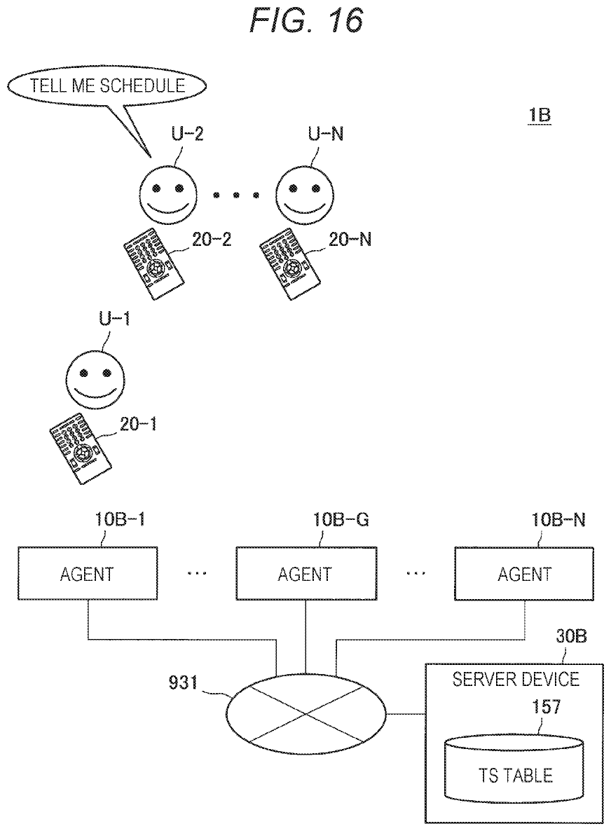

First, an exemplary configuration of an information processing system according to the second embodiment will be described with reference to the drawings. FIG. 16 is a diagram illustrating the exemplary configuration of the information processing system according to the second embodiment. As illustrated in FIG. 16, an information processing system 1B according to the second embodiment includes agents 10B-1 to 10B-N, controllers 20-1 to 20-N (N is a natural number), and a server device 30B. Note that, although the number of the agents 10 and the number of the controllers 20 are the same in the example illustrated in FIG. 16, the number of the agents 10 and the number of the controllers 20 may be different.

As illustrated in FIG. 16, in a case where a request “tell me the schedule” has been made by a user U-2, it is necessary to specify which one of the agents 10B-1 to 10B-N should process the request. Note that the server device 30B stores a task status table 157 in the second embodiment. The task status table 157 manages a task of each of the agents 10B-1 to 10B-N. The task status table 157 will be described later.

The exemplary configuration of the information processing system 1B according to the second embodiment has been described as above.

[2.2. Exemplary Functional Configuration of Agent]

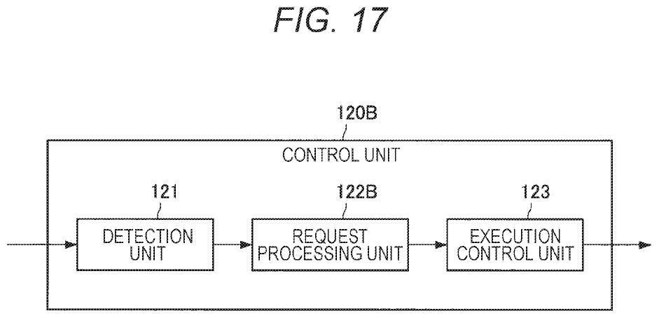

Next, an exemplary functional configuration of the agent 10B according to the second embodiment will be described. The agent 10B according to the second embodiment is different from the agent 10A according to the first embodiment in that a control unit 120B is included instead of the control unit 120A. Hereinafter, the exemplary functional configuration of the control unit 120B will be mainly described. FIG. 17 is a diagram illustrating an exemplary detailed configuration of the control unit 120B. As illustrated in FIG. 17, the control unit 120B includes a detection unit 121, a request processing unit 122B, and an execution control unit 123. Hereinafter, the request processing unit 122B will be mainly described.

The exemplary functional configuration of the agent 10B according to the second embodiment has been described as above.

[2.3. Exemplary Functional Configuration of Server Device]

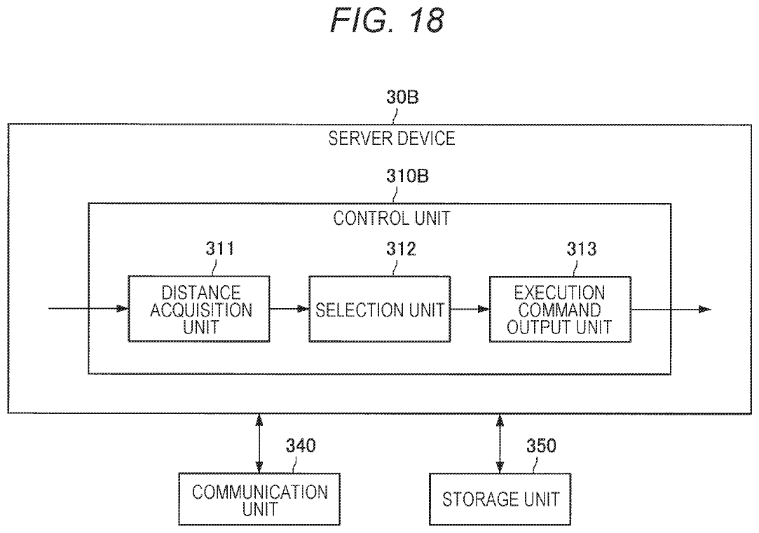

Next, an exemplary functional configuration of the server device 30B according to the second embodiment will be described. FIG. 18 is a diagram illustrating the exemplary functional configuration of the server device 30B according to the second embodiment. As illustrated in FIG. 18, the server device 30B according to the second embodiment is different from the server device 30A according to the first embodiment in that a control unit 310B is included instead of the control unit 310A. Specifically, the control unit 310B includes a distance acquisition unit 311, a selection unit 312, and an execution command output unit 313. Hereinafter, an exemplary functional configuration of the control unit 310B will be mainly described.

The exemplary functional configuration of the server device 30B according to the second embodiment has been described as above.

[2.4. Functional Detail of Information Processing System]

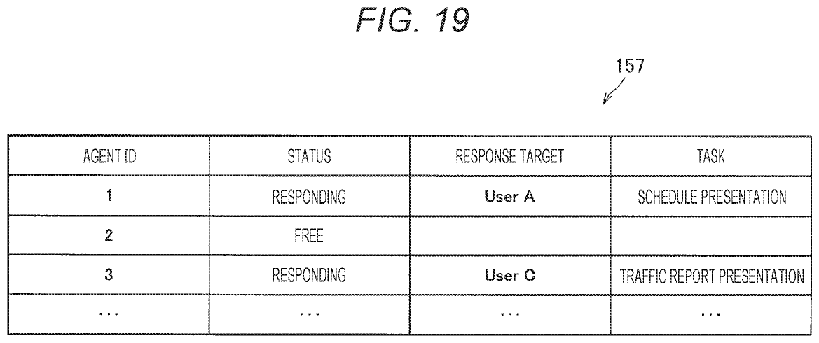

Next, functional details of the information processing system 1B according to the second embodiment will be described. FIG. 19 is a diagram illustrating an example of the task status table. As illustrated in FIG. 19, in the task status table 157, an agent ID, a status (e.g., whether a response to a request is in processing, whether there is no request to be processed (whether it is free), etc.), identification information of a user to be responded, and a type of the task corresponding to the request in processing are associated with each other.

At this time, for example, in a case where the server device 30B determines that the agent 10B-1 among the agents 10B-1 to 10B-2 should process the request from the user U-2, the request processing unit 122B of the agent 10B-1 may execute the request from the user U-2 (e.g., the request from the user U-2 may be added to a request queue).

On the other hand, in a case where it is not determined that the agent 10B-1 among the agents 10B-1 to 10B-2 should process the request from the user U-2, the request processing unit 122B of the agent 10B-1 does not need to execute the request from the user U-2 (e.g., the request from the user U-2 is not required to be added to the request queue).

For example, the server device 30B may determine that the agent 10B-1 should process the request from the user U-2 in a case where the agent 10B-1 among the agents 10B-1 to 10B-2 is closest to the user U-2. Alternatively, the server device 30B may determine that the agent 10B-1 should process the request from the user U-2 in a case where the agent 10B-1 among the agents 10B-1 to 10B-2 does not have a request to be processed (task corresponding to the request).

In this manner, in a case where the agent 10B-1 does not have a request to be processed (task corresponding to the request), while it may be determined that the agent 10B-1 should process the request from the user U-2, there may be assumed a case where the agent 10B-1 is far from the user U-2. Therefore, in such a case, the request processing unit 122B of the agent 10B-1 may change the response to the request. For example, the request processing unit 122B may set the response to the request to be a combination of voice and screen display, may set the response to the request to be voice and louden the voice, or may set the response to the request to be screen display and enlarge display characters of the screen.

The functional details of the information processing system 1B according to the second embodiment have been described as above.

[2.5. Exemplary Operation]

Next, exemplary operation of the information processing system 1B according to the second embodiment will be described. FIG. 20 is a flowchart illustrating exemplary operation of determining whether or not the request is to be executed in the agent 10B-1. Note that similar operation may be performed in the agents 10B-2 to 10B-N as well. As illustrated in FIG. 20, when the request processing unit 122B of the agent 10B-1 receives the request from the user U-2 (S41), it transmits the distance between the user U-2 and the agent 10B-1 to the server device 30B (S42).

When a communication unit 140 receives, from the server device 30B, a response execution command with respect to the request (“Yes” in S43), the request processing unit 122B executes a response to the request (S44). On the other hand, when the communication unit 140 does not receive, from the server device 30B, the response execution command with respect to the request (“No” in S43), the request processing unit 122B terminates the operation without executing a response to the request.

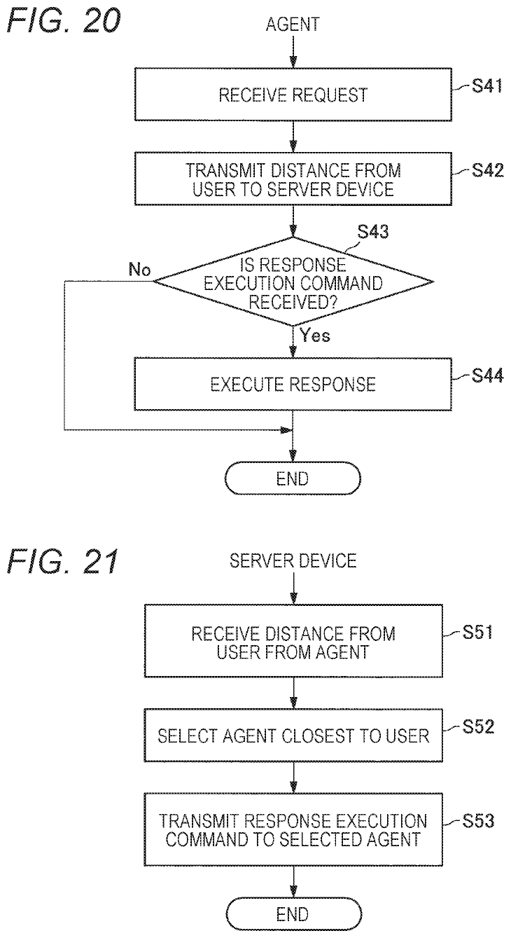

FIG. 21 is a flowchart illustrating exemplary operation of selecting an agent to execute the request in the server device 30B. As illustrated in FIG. 21, in the server device 30B, a communication unit 340 receives the distance between the agent 10B-1 and the user U-2 from the agent 10B-1 (S51). The distance is also received from the agents 10B-2 to 10B-N in a similar manner. The distance acquisition unit 311 obtains such distances.

Subsequently, the selection unit 312 selects the agent closest to the user U-2 from among the agents 10B-1 to 10B-N (S52). The execution command output unit 313 causes the agent selected by the selection unit 312 to transmit a response execution command (S53). When the transmission of the response execution command is complete, the operation is terminated.

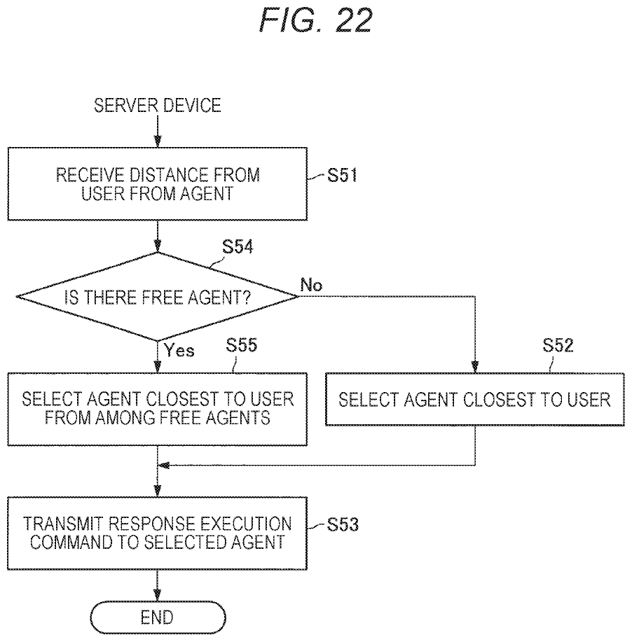

FIG. 22 is a flowchart illustrating another exemplary operation of selecting an agent to execute the request in the server device 30B. As illustrated in FIG. 22, in the server device 30B, the communication unit 340 receives the distance between the agent 10B-1 and the user U-2 from the agent 10B-1 (S51). The distance is also received from the agents 10B-2 to 10B-N in a similar manner. The distance acquisition unit 311 obtains such distances.

Subsequently, the selection unit 312 determines whether or not a free agent exists (S54). In a case where no free agent exists (“No” in S54), the selection unit 312 selects the agent closest to the user U-2 (S52), and proceeds to S53. On the other hand, in a case where a free agent exists (“Yes” in S54), the selection unit 312 selects the agent closest to the user U-2 from among the free agents (S55). The execution command output unit 313 causes the agent selected by the selection unit 312 to transmit a response execution command (S53). When the transmission of the response execution command is complete, the operation is terminated.

The exemplary operation of the information processing system 1B according to the second embodiment has been described as above.

In the foregoing, the second embodiment has been described.

### 3. Third Embodiment

Next, a third embodiment will be described. In the third embodiment as well, in a similar manner to the second embodiment, there are a plurality of agents 10.

[3.1. Exemplary System Configuration]

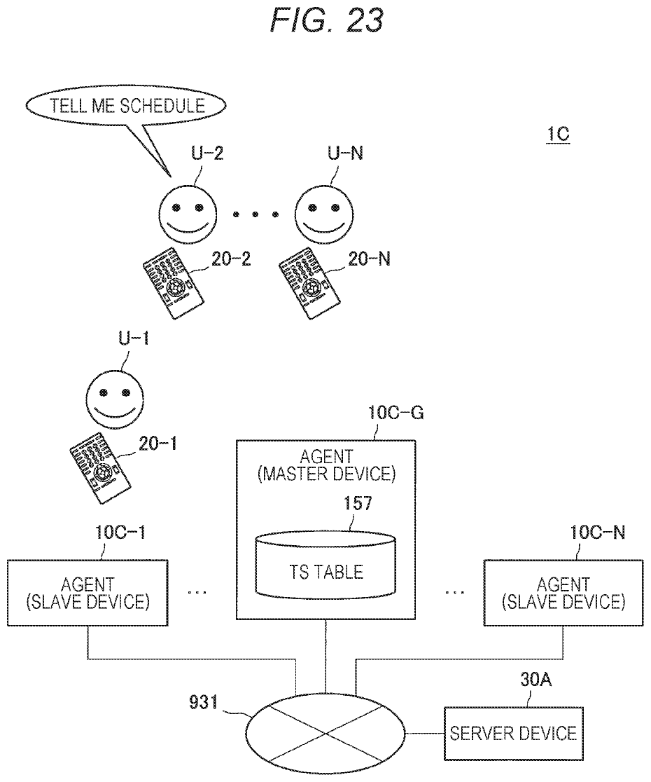

First, an exemplary configuration of an information processing system according to the third embodiment will be described with reference to the drawings. FIG. 23 is a diagram illustrating the exemplary configuration of the information processing system according to the third embodiment. As illustrated in FIG. 23, an information processing system 1C according to the third embodiment includes agents 10C-1 to 10C-N, controllers 20-1 to 20-N (N is a natural number), and a server device 30A. Note that, although the number of the agents 10 and the number of the controllers 20 are the same in the example illustrated in FIG. 23, in a similar manner to the second embodiment, the number of the agents 10 and the number of the controllers 20 may be different.

As illustrated in FIG. 23, in a similar manner to the second embodiment, in a case where a request “tell me the schedule” has been made by a user U-2, it is necessary to specify which one of the agents 10C-1 to 10C-N should process the request. Note that an agent 10C-G (master device) stores a task status table 157 in the third embodiment. Furthermore, among the plurality of agents 10, agents other than the agent 10C-G (master device) function as slave devices.

The agent 10C-G (master device) may be determined in any way. For example, the agent 10C-G (master device) may be manually determined by a user. Alternatively, the agent 10C-G (master device) may be automatically determined by the system (e.g., server device 30A, etc.) from among the agents existing within the communication range. For example, the agent 10C-G (master device) may be randomly determined, or may be determined to be the agent having the highest contact frequency with the user. Furthermore, the slave devices are capable of communicating with each other using short-range wireless communication or the like.

The exemplary configuration of the information processing system 1C according to the third embodiment has been described as above.

[3.2. Exemplary Functional Configuration of Master Device]

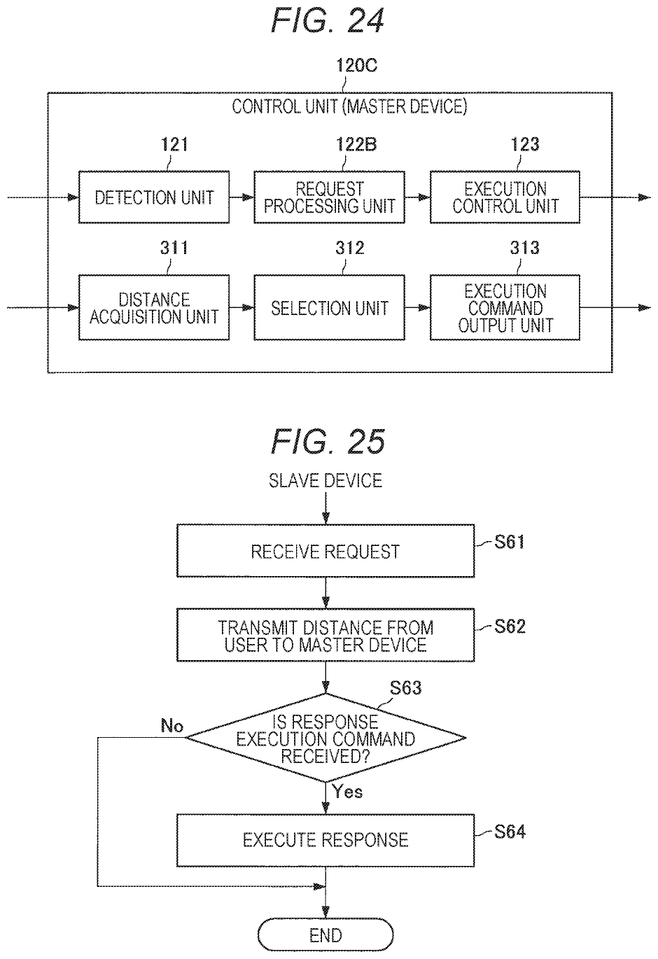

Next, an exemplary functional configuration of the agent 10C-G (master device) according to the third embodiment will be described. The agent 10C-G (master device) according to the third embodiment is different from the agent 10B according to the second embodiment in that a control unit 120C is included instead of the control unit 120B. Hereinafter, an exemplary functional configuration of the control unit 120C will be mainly described. FIG. 24 is a diagram illustrating an exemplary detailed configuration of the control unit 120C.

As illustrated in FIG. 24, the control unit 120C of the agent 10C-G (master device) includes a detection unit 121, a request processing unit 122B, and an execution control unit 123. Moreover, the control unit 120C of the agent 10C-G (master device) includes a distance acquisition unit 311, a selection unit 312, and an execution command output unit 313.

The exemplary functional configuration of the agent 10C-G (master device) according to the third embodiment has been described as above.

[3.3. Exemplary Operation]

Next, exemplary operation of the information processing system 1C according to the third embodiment will be described. FIG. 25 is a flowchart illustrating exemplary operation of determining whether or not a request is to be executed in the agent 10C-1 (slave device). Note that similar operation may be performed in other slave devices. As illustrated in FIG. 25, when the request processing unit 122B of the agent 10C-1 (slave device) receives the request from the user U-2 (S61), it transmits the distance between the user U-2 and the agent 10C-1 (slave device) to the agent 10C-G (master device) (S62).

When a communication unit 140 receives, from the agent 10C-G (master device), a response execution command with respect to the request (“Yes” in S63), the request processing unit 122B executes a response to the request (S64). On the other hand, when the communication unit 140 does not receive, from the agent 10C-G (master device), the response execution command with respect to the request (“No” in S63), the request processing unit 122B terminates the operation without executing a response to the request.

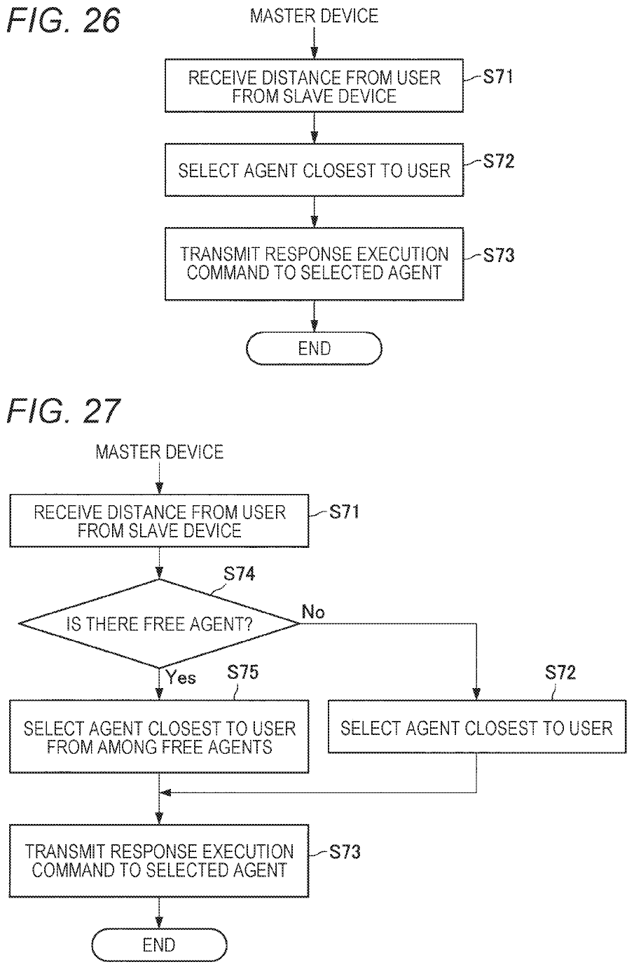

FIG. 26 is a flowchart illustrating exemplary operation of selecting an agent to execute the request in the agent 10C-G (master device). As illustrated in FIG. 26, in the agent 10C-G (master device), a communication unit 340 receives, from the agent 10C-1 (slave device), the distance between the agent 10C-1 and the user U-2 (S71). Distances are also received from other slave devices in a similar manner. The distance acquisition unit 311 obtains such distances.

Subsequently, the selection unit 312 selects the agent closest to the user U-2 from among all slave devices (S72). The execution command output unit 313 causes the agent selected by the selection unit 312 to transmit a response execution command (S73). When the transmission of the response execution command is complete, the operation is terminated.

FIG. 27 is a flowchart illustrating another exemplary operation of selecting the agent to execute the request in the agent 10C-G (master device). As illustrated in FIG. 27, in the agent 10C-G (master device), the communication unit 340 receives, from the agent 10C-1 (slave device), the distance between the agent 10C-1 (slave device) and the user U-2 (S71). Distances are also received from other slave devices in a similar manner. The distance acquisition unit 311 obtains such distances.

Subsequently, the selection unit 312 determines whether or not a free agent exists (S74). In a case where no free agent exists (“No” in S74), the selection unit 312 selects the agent closest to the user U-2 (S72), and proceeds to S73. On the other hand, in a case where a free agent exists (“Yes” in S74), the selection unit 312 selects the agent closest to the user U-2 from among the free agents (S75). The execution command output unit 313 causes the agent selected by the selection unit 312 to transmit a response execution command (S73). When the transmission of the response execution command is complete, the operation is terminated.

The exemplary operation of the information processing system 1C according to the third embodiment has been described as above.

In the foregoing, the third embodiment has been described.

<4. Overview (Control of Presentation Information to User)>

In the foregoing description, the technique of determining the request to be preferentially processed has been mainly described. Hereinafter, a technique of controlling presentation information to the user will be mainly described. In recent years, a technique associated with a robot apparatus for making dialogue with a user has been known. For example, there has been disclosed a technique of presenting presentation information to the user according to an emotion of the user determined from content of utterance of the user and an intimacy level with the user registered in advance.

Furthermore, there has also been known a technique associated with an agent that makes dialogue with the user on the basis of presentation information mainly including audio information. There has also been known a technique associated with an agent that presents, as presentation information, not only audio information but also video information to the user. In this manner, in a case where both the audio information and the video information can be presented to the user as the presentation information, it is considered that a dialogue desirable for the user is made by the audio information and the video information being effectively presented to the user.

Here, two specific examples will be described. As a first example, it is assumed a case where the user has requested the agent to present information associated with weather. In such a case, it is conceivable that only the audio information (e.g., audio information “it will be sunny tomorrow”, etc.) is presented in response to the request from the user in the state of not being able to view the screen. On the other hand, the user in the state of being able to view the screen can use not only the audio information but also the video information displayed on the screen. However, if the audio information having the contents same as the contents that can be presented by the video information is presented to the user, presentation to the user may be redundant.

As a second example, it is assumed a case where the user has requested the agent to present recommendation information regarding a visiting destination. In such a case, it is conceivable that recommended spots are sequentially presented by audio information from the beginning to the end, such as the audio information “Recommendation spots are A, B, C, and so on.”, to the user in the state of not being able to view the screen. On the other hand, if only similar audio information is presented to the user in the state of being able to view the screen, the user is forced to wait until all of the recommended spots are heard despite the video information can be used.

Assuming such an exemplary case, for example, the audio information and the video information to be presented to the user are preferably controlled depending on whether or not the user is currently viewing the screen. For example, in the first example, while the information associated with the weather is presented to the user currently viewing the screen by the video information, additional information (e.g., additional information such as “It's hot today, so stay hydrated.”) is presented by the audio information, whereby presentation suitable for the user can be performed. On the other hand, only the audio information may be presented in response to the request from the user not currently viewing the screen.

In the second example, while a list of the recommendation information is presented to the user currently viewing the screen by the video information, a directive (e.g., directive such as “Are there any places you are interested in?”) is concisely presented by the audio information, whereby presentation suitable for the user can be performed. On the other hand, only the audio information may be presented in response to the request from the user not currently viewing the screen.

As described above, for example, it is considered that the video information and the audio information to be presented to the user are preferably controlled depending on whether or not the user is currently viewing the screen. Hereinafter, the technique capable of controlling a plurality of pieces of presentation information to be presented to the user as desired by the user will be mainly described. Note that, although the type of each of the plurality of pieces of presentation information is not limited, in a similar manner to the exemplary case described above, a case where the plurality of pieces of presentation information includes the video information and the audio information will be mainly assumed. The video information may be a still image, or may be a moving image.

In the foregoing, the overview of the technique of controlling the presentation information to the user has been described.

### 5. Fourth Embodiment

Next, a fourth embodiment will be described. In the first embodiment, a case where there is one agent 10 has been mainly assumed. In the fourth embodiment as well, a case where there is one agent 10 will be mainly described. However, there may be a plurality of agents 10 instead of one.

[5.1. Exemplary System Configuration]

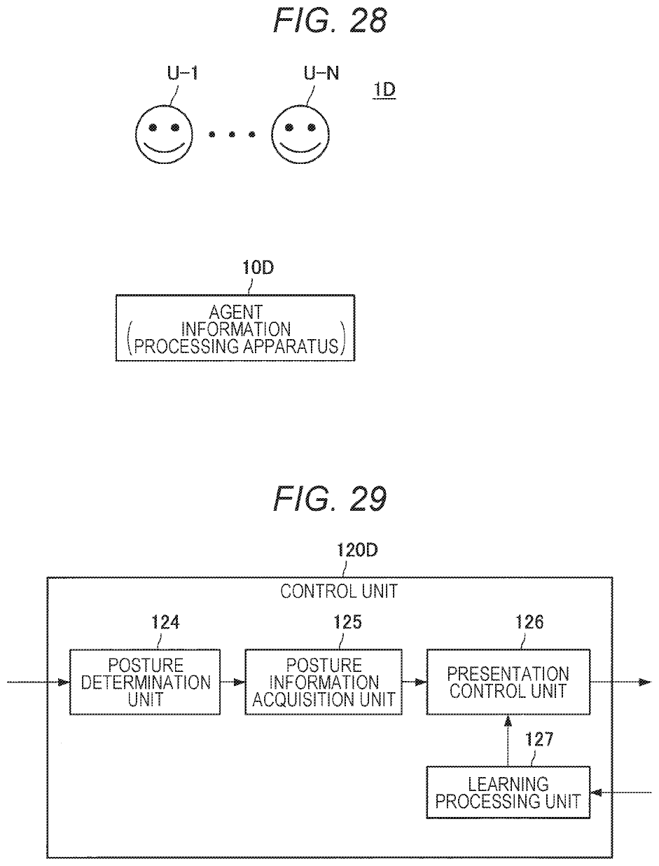

First, an exemplary configuration of an information processing system according to the fourth embodiment will be described with reference to the drawings. FIG. 28 is a diagram illustrating the exemplary configuration of the information processing system according to the fourth embodiment. As illustrated in FIG. 28, an information processing system 1D according to the fourth embodiment includes an agent 10D. Note that, although a case where there is no server device capable of communicating with the agent 10D via a communication network will be mainly assumed in the fourth embodiment, the information processing system 1D may include such a server device.

Furthermore, in the fourth embodiment, a case where presentation information is presented to a user U-1 in response to a request will be mainly assumed. However, the presentation information may be presented to the user U-1 regardless of whether or not the request is made from the user U-1. Furthermore, in the fourth embodiment, a case where the request is made by the user U-1 on the basis of utterance will be mainly described. However, the request may be made on the basis of operation performed on a controller in a similar manner to the first to third embodiments. Note that the presentation information may be presented to users U-2 to U-N as well, in a similar manner to the user U-1.

The exemplary configuration of the information processing system 1D according to the fourth embodiment has been described as above.

[5.2. Exemplary Functional Configuration of Agent]

Next, an exemplary functional configuration of the agent 10D according to the fourth embodiment will be described. The agent 10D according to the fourth embodiment is different from the agent 10A according to the first embodiment in that a control unit 120D is included instead of the control unit 120A. Hereinafter, an exemplary functional configuration of the control unit 120D will be mainly described. FIG. 29 is a diagram illustrating an exemplary detailed configuration of the control unit 120D. As illustrated in FIG. 29, the control unit 120D includes a posture determination unit 124, a posture information acquisition unit 125, a presentation control unit 126, and a learning processing unit 127.

The exemplary functional configuration of the agent 10D according to the fourth embodiment has been described as above.

[5.3. Functional Detail of Information Processing System]

Next, functional details of the information processing system 1D according to the fourth embodiment will be described. In the fourth embodiment, the posture determination unit 124 obtains posture information of the user U-1 by obtaining sensor data and determining a posture of the user U-1 on the basis of the sensor data. Although the case where the sensor data is an image captured by an imaging unit 114 will be mainly assumed in the fourth embodiment, the sensor data is not limited to the image captured by the imaging unit 114. For example, in a case where a sensor (e.g., acceleration sensor, etc.) is attached to the user U-1, the sensor data may be detected by the sensor attached to the user U-1. Note that the posture determination unit 124 may exist in the server device instead of the agent 10D.

The posture information of the user U-1 may be information based on the orientation of a part of or all of the body of the user U-1. For example, the posture information of the user U-1 may include the orientation of the face of the user U-1, or the line of sight of the user U-1. Furthermore, the posture information of the user U-1 may include pose information of the user U-1. The pose information may be body shape data (e.g., skeletal information, etc.) itself, or may be a classification result (e.g., standing state, sitting state, etc.) of the body shape data. Furthermore, the posture information of the user U-1 may include behavior information (e.g., reading, cleaning, eating, etc.) of the user U-1.

The posture information acquisition unit 125 obtains the posture information of the user U-1 determined by the posture determination unit 124. Then, the presentation control unit 126 controls the presentation of the presentation information to the user U-1. At this time, the presentation control unit 126 controls a plurality of pieces of presentation information having different aspects on the basis of the posture information of the user U-1. According to such a configuration, it becomes possible to further control the plurality of pieces of presentation information to be presented to the user U-1 as desired by the user U-1. Note that, as described above, the case where the plurality of pieces of presentation information includes the video information and the audio information is mainly assumed in the fourth embodiment.

An exemplary correspondence relationship between the posture information of the user U-1 and the video information and the audio information will be described specifically. In the fourth embodiment, presentation based on an “audio video presentation mode” and presentation based on an “audio-based presentation mode” are assumed. In other words, in a case where the posture information of the user U-1 satisfies a first condition (hereinafter also referred to as “screen viewing condition”), the presentation control unit 126 controls the presentation based on the “audio video presentation mode” associated with the screen viewing condition. Meanwhile, in a case where the posture information of the user U-1 satisfies a second condition (hereinafter also referred to as “screen non-viewing condition”), the presentation control unit 126 controls the presentation based on the “audio-based presentation mode” associated with the screen non-viewing condition.

Here, the “audio video presentation mode” is a mode for presenting both the video information and the audio information to the user U-1. In other words, in a case where the screen viewing condition is satisfied, the presentation control unit 126 controls the presentation of both of the video information and the audio information associated with the screen viewing condition for the user U-1. The presentation of the audio information may be performed in any way. For example, the presentation of the audio information may be performed by the text to speech (TTS). However, in the “audio video presentation mode”, the audio information may not be presented to the user U-1 (it is preferable to be presented).

Meanwhile, the “audio-based presentation mode” is a mode for presenting audio information to the user U-1. In other words, in a case where the screen non-viewing condition is satisfied, the presentation control unit 126 controls the presentation of the audio information associated with the screen non-viewing condition for the user U-1. However, in the “audio-based presentation mode”, the video information may be presented to the user U-1 in addition to the audio information. In other words, in a case where the screen non-viewing condition is satisfied, the presentation control unit 126 further controls the presentation of the video information associated with the screen non-viewing condition for the user U-1. However, even in the case where the video information is presented to the user U-1, the audio information is preferably presented such that the user U-1 can sufficiently understand the response contents only by the audio information.

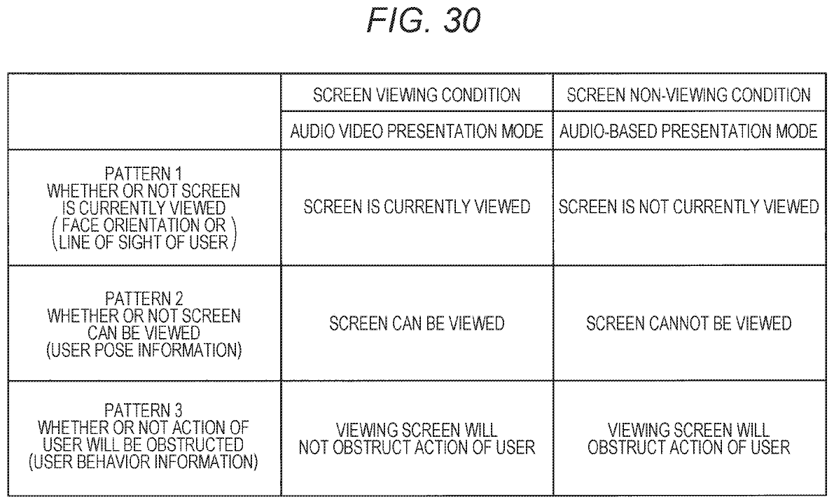

FIG. 30 is a diagram illustrating an exemplary correspondence relationship between each condition and a presentation mode. As illustrated in FIG. 30, the screen viewing condition may include a condition that the user U-1 is currently viewing a screen on which the video information is displayed (hereinafter also simply referred to as “screen”). Furthermore, the screen viewing condition may include a condition that the user U-1 is in a state being able to view the screen. Furthermore, the screen viewing condition may include a condition that the viewing of the screen does not obstruct an action of the user U-1.

Meanwhile, as illustrated in FIG. 30, the screen non-viewing condition may include a condition that the user U-1 is not currently viewing the screen. Furthermore, the screen non-viewing condition may include a condition that the user U-1 is in a state not being able to view the screen. Furthermore, the screen non-viewing condition may include a condition that the viewing of the screen obstructs the action of the user U-1.

For example, as illustrated in FIG. 30, whether or not the user U-1 is currently viewing the screen (pattern 1) can be determined by the presentation control unit 126 on the basis of the orientation of the face of the user U-1 or the line of sight of the user U-1. Specifically, in a case where the orientation of the face or the line of sight of the user U-1 has a predetermined positional relationship with the screen, the presentation control unit 126 may determine that the user U-1 is currently viewing the screen. On the other hand, in a case where the orientation of the face or the line of sight of the user U-1 does not have a predetermined positional relationship with the screen, the presentation control unit 126 may determine that the user U-1 is not currently viewing the screen.

Here, a position of the screen may be set in any way. For example, in a case where the position of the screen has been automatically recognized on the basis of the image captured by the imaging unit 114, the position of the recognized screen may be automatically set. Alternatively, the position of the screen may be manually set in advance.

More specifically, in a case where the orientation of the face or the line of sight of the user U-1 (or frustum based on the orientation of the face, or frustum based on the line of sight) intersects the screen, the presentation control unit 126 may determine that the user U-1 is currently viewing the screen. On the other hand, in a case where the orientation of the face or the line of sight of the user U-1 (or frustum based on the orientation of the face, or frustum based on the line of sight) does not intersect the screen, the presentation control unit 126 may determine that the user U-1 is not currently viewing the screen.

Moreover, even in the case where the orientation of the face or the line of sight of the user U-1 (or frustum based on the orientation of the face, or frustum based on the line of sight) intersects the screen, the presentation control unit 126 may determine that the user U-1 is not currently viewing the screen in a case where the user U-1 does not exist within the maximum viewable distance. For example, in a case where characters are displayed on the current screen, the presentation control unit 126 may calculate the maximum viewable distance on the basis of the display size of the characters.

Moreover, even in the case where the orientation of the face or the line of sight of the user U-1 (or frustum based on the orientation of the face, or frustum based on the line of sight) intersects the screen, the presentation control unit 126 may determine that the user U-1 is not currently viewing the screen in a case where a shielding object exists between the user U-1 and the screen. For example, in a case where an object is detected between the user U-1 and the screen on the basis of the image captured by the imaging unit 114, the presentation control unit 126 may determine that a shielding object exists between the user U-1 and the screen.

Furthermore, as illustrated in FIG. 30, whether or not the user U-1 is in the state of being able to view the screen (pattern 2) can be determined by the presentation control unit 126 on the basis of the pose information of the user U-1. Specifically, in a case where the viewable range (e.g., angular width of the face orientation, etc.) of the user U-1 according to the pose information of the user U-1 is calculated and the viewable range has a predetermined positional relationship with the screen, the presentation control unit 126 may determine that the user U-1 is in the state of being able to view the screen. On the other hand, in a case where the viewable range does not have the predetermined positional relationship with the screen, the presentation control unit 126 may determine that the user U-1 is in the state of being unable to view the screen.

For example, the relationship between the pose information of the user U-1 and the viewable range of the user U-1 may be determined in advance. For example, in a case where the pose information of the user U-1 indicates a “standing state”, the viewable range may be wider than the case where the pose information of the user U-1 indicates a “sitting state”.

More specifically, in a case where the viewable range of the user U-1 according to the pose information of the user U-1 intersects the screen, the presentation control unit 126 may determine that the user U-1 is in the state of being able to view the screen. On the other hand, in a case where the viewable range of the user U-1 according to the pose information of the user U-1 does not intersect the screen, the presentation control unit 126 may determine that the user U-1 is in the state of being unable to view the screen.

Moreover, even in the case where the viewable range of the user U-1 according to the pose information of the user U-1 intersects the screen, the presentation control unit 126 may determine that the user U-1 is in the state of being unable to view the screen in a case where the user U-1 does not exist within the maximum viewable distance. Alternatively, even in the case where the viewable range of the user U-1 according to the pose information of the user U-1 intersects the screen, the presentation control unit 126 may determine that the user U-1 is in the state of being unable to view the screen in a case where a shielding object exists between the user U-1 and the screen.

Furthermore, as illustrated in FIG. 30, whether or not the viewing of the screen obstructs an action of the user U-1 (pattern 3) can be determined by the presentation control unit 126 on the basis of the behavior information of the user U-1. Specifically, in a case where the behavior information of the user U-1 is first behavior information (e.g., state of sitting on a sofa, etc.), the presentation control unit 126 may determine that the viewing of the screen does not obstruct the action of the user U-1. On the other hand, in a case where the behavior information of the user U-1 is second behavior information (e.g., reading, cleaning, eating, etc.), the presentation control unit 126 may determine that the viewing of the screen obstructs the action of the user U-1.

As described above, the association between the screen viewing condition and the “audio video presentation mode”, and the association between the screen non-viewing condition and the “audio-based presentation mode” may be uniformly performed without depending on the user. However, which presentation mode is desired by the user in the case of which condition being satisfied may be different depending on the user. In view of the above, the association between the screen viewing condition and the “audio video presentation mode”, and the association between the screen non-viewing condition and the “audio-based presentation mode” may be performed for each user. In addition, those associations may be changeable for each user.

For example, in a case where, after the presentation to the user U-1 based on the audio video presentation mode associated with the screen viewing condition is controlled, a first state of the user U-1 is detected, the learning processing unit 127 may change the association between the audio video presentation mode and the screen viewing condition corresponding to the user U-1. Then, the learning processing unit 127 may newly associate the audio-based presentation mode with the screen viewing condition corresponding to the user U-1.

Here, the first state may be a predetermined change operation performed by the user U-1. For example, the change operation may be a predetermined gesture indicating a change, may be utterance indicating a change, or may be another operation. Alternatively, the first state may be a state in which the user U-1 is not viewing the screen (state in which the orientation of the face or the line of sight of the user U-1 does not have a predetermined positional relationship with the screen).

Meanwhile, in a case where, after the presentation to the user U-1 based on the audio-based presentation mode associated with the screen non-viewing condition is controlled, a second state of the user U-1 is detected, the learning processing unit 127 may change the association between the audio-based presentation mode and the screen non-viewing condition corresponding to the user U-1. Then, the learning processing unit 127 may newly associate the audio video presentation mode with the screen non-viewing condition of the user U-1.

Here, the second state may be a predetermined change operation performed by the user U-1. For example, the change operation may be a predetermined gesture indicating a change, may be utterance indicating a change, or may be another operation. Alternatively, the second state may be a state in which the user U-1 is viewing the screen (state in which the orientation of the face or the line of sight of the user U-1 has a predetermined positional relationship with the screen).

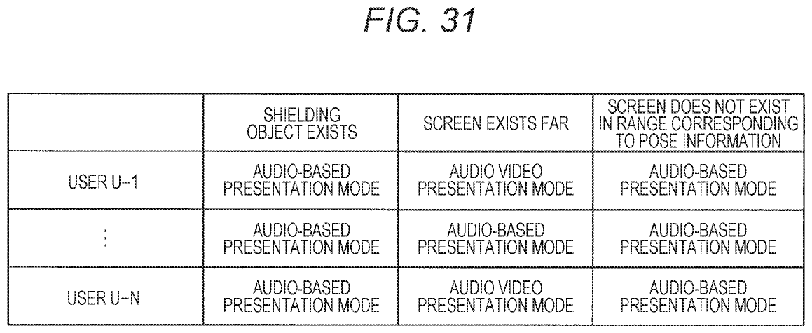

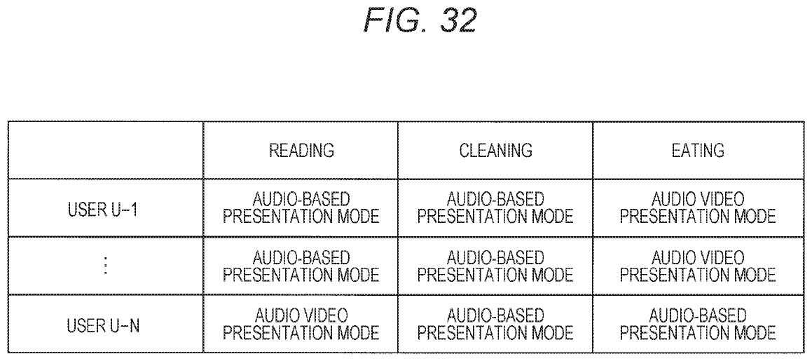

FIGS. 31 and 32 are diagrams illustrating an exemplary correspondence relationship between each condition for each user and the presentation mode. Referring to FIG. 31, there is illustrated a condition that the screen does not exist in the range (viewable range) corresponding to the pose information as an example of the screen non-viewing condition. For each of the users U-1 to U-N, the audio-based presentation mode is associated with the condition that the screen does not exist in the range (viewable range) corresponding to the pose information. In addition, referring to FIG. 31, there is illustrated a condition that a shielding object exists. For each of the users U-1 to U-N, the audio-based presentation mode is associated with the condition that a shielding object exists between the user and the screen.

Furthermore, referring to FIG. 31, there is illustrated a condition that the screen is located far away. For the user U-1 and the user U-N, a change is made such that the audio video presentation mode is associated with the condition that the user exists far from the screen (the user does not exist within the maximum viewable distance from the screen). For other users U-2 to U-(N−1), the audio-based presentation mode is associated with the condition that the user exists far from the screen (the user does not exist within the maximum viewable distance from the screen).

Referring to FIG. 32, the condition that the behavior information of the user is the second behavior information (e.g., any of reading, cleaning, and eating) is illustrated as an example of the screen non-viewing condition. For the user U-N, a change is made such that the audio video presentation mode is associated with the condition that the behavior information of the user is “reading”. For each of the users U-1 to U-(N−1), the audio-based presentation mode is associated with the condition that the behavior information of the user is “reading”.

Furthermore, for each of the users U-1 to U-N, the audio-based presentation mode is associated with the condition that the behavior information of the user is “cleaning”. Furthermore, for the users U-1 to U-(N−1), a change is made such that the audio video presentation mode is associated with the condition that the behavior information of the user is “eating”. For the user U-N, the audio-based presentation mode is associated with the condition that the behavior information of the user is “eating”.

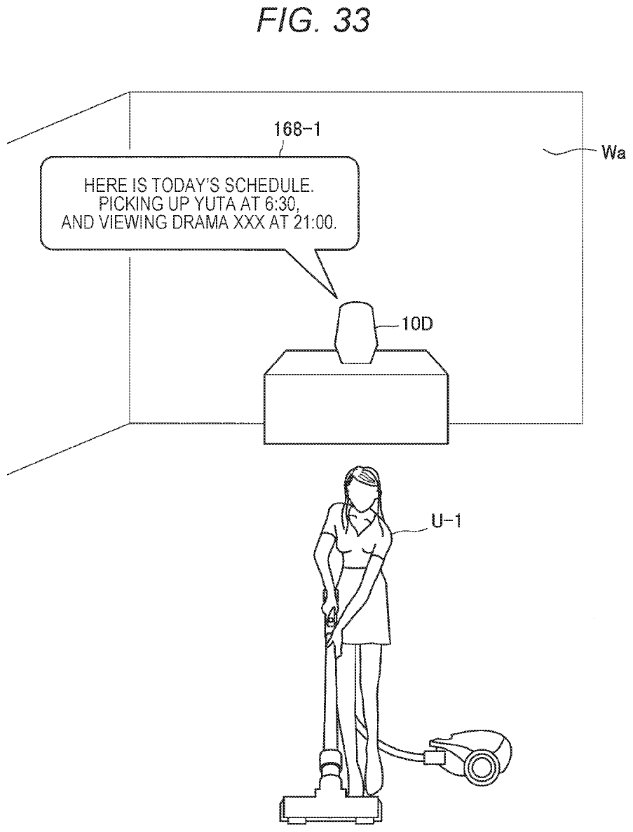

Hereinafter, a specific example of the presentation information will be described. FIG. 33 is a diagram illustrating exemplary presentation in the audio-based presentation mode. Here, a case where the user U-1 inputs the request “presentation of today's schedule” by utterance of “tell me today's schedule” is assumed. In FIG. 33, a wall surface Wa is illustrated as a screen on which the video information is presented. However, the user U-1 is not viewing the screen (e.g., because he/she is doing cleaning). Accordingly, the presentation control unit 126 determines that the posture information of the user U-1 satisfies the screen non-viewing condition, and controls the presentation in the audio-based presentation mode.

As described above, in the audio-based presentation mode, the presentation control unit 126 may present only the audio information to the user U-1 (video information may not be presented). At this time, the audio information is preferably presented such that the user U-1 can sufficiently understand the response contents only by the audio information. In the example illustrated in FIG. 33, audio information 168-1 includes today's schedule.

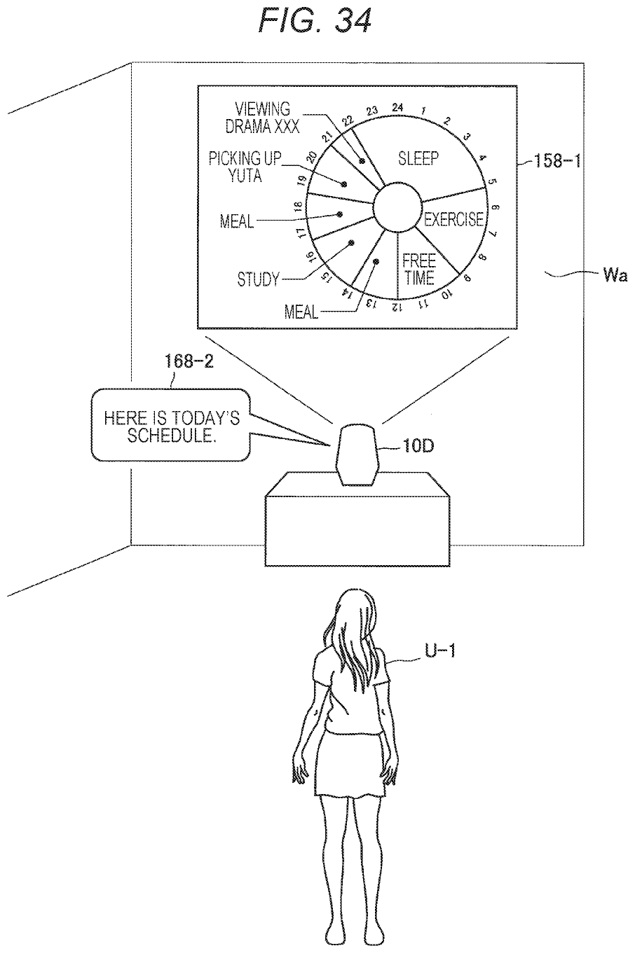

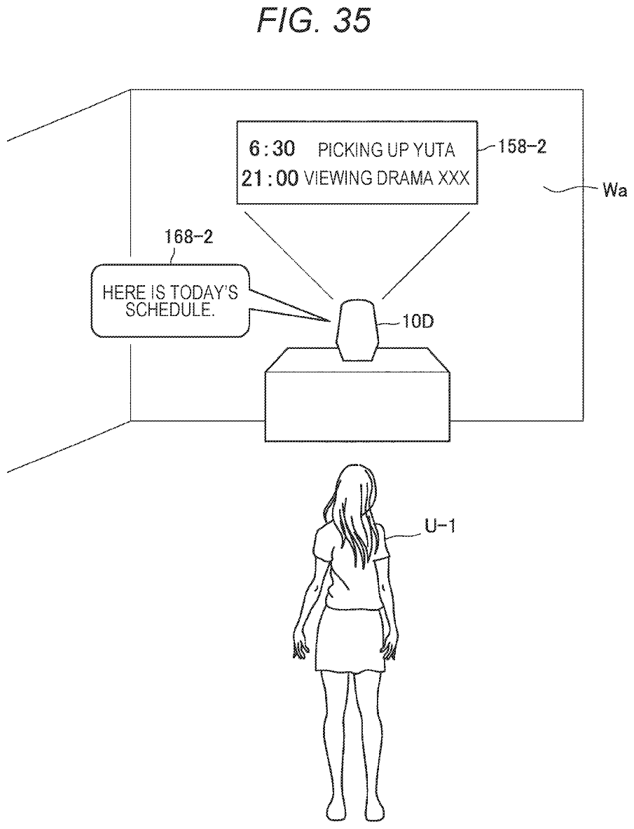

FIGS. 34 and 35 are diagrams illustrating exemplary presentation in the audio video presentation mode. Here again, the case where the user U-1 inputs the request “presentation of today's schedule” by utterance of “tell me today's schedule” is assumed. In the examples illustrated in FIGS. 34 and 35, the user U-1 is viewing the screen. Accordingly, the presentation control unit 126 determines that the posture information of the user U-1 satisfies the screen viewing condition, and controls the presentation in the audio video presentation mode.

As described above, in the audio video presentation mode, the presentation control unit 126 may present both the video information and the audio information to the user U-1. At this time, since the screen viewing condition is satisfied, the video information presented in the audio video presentation mode may have an information volume larger than that of the video information presented in the audio-based presentation mode. On the other hand, the audio information presented in the audio video presentation mode may have an information volume smaller than that of the audio information presented in the audio-based presentation mode.

For example, the video information presented in the audio video presentation mode may include at least one of graphics or text data. In the example illustrated in FIG. 34, the presentation control unit 126 controls the presentation of the schedule (pie chart) using both graphics and text data as video information 158-1. At this time, the audio information presented in the audio video presentation mode may be brief audio information (it may include at least one of a directive or an abbreviation). In the example illustrated in FIG. 34, the presentation control unit 126 controls the presentation of brief audio information 168-2 including the directive “here”.

In the example illustrated in FIG. 35, the presentation control unit 126 controls the presentation of the schedule using text data as video information 158-2. Furthermore, in the example illustrated in FIG. 35, in a similar manner to the example illustrated in FIG. 34, the presentation control unit 126 controls the presentation of the brief audio information 168-2 including the directive “here”.

In addition, in the audio video presentation mode, the presentation control unit 126 may perform control such that contents difficult to describe in words are presented by the video information. For example, it is assumed a case where a candidate for the request is found. In such a case, while the presentation control unit 126 controls presentation of brief audio information such as “how about this?”, it may perform control such that an image of the candidate is presented by graphics.

Furthermore, while the presentation control unit 126 controls presentation of brief audio information such as “how about this size?”, it may control presentation such that a sense of the size of the candidate is understood by graphics. More specifically, the presentation by which the sense of the size of the candidate is understood may be presentation of an image of an object having a size similar to that of the candidate (e.g., three times the size of Tokyo Dome, notebook of A4 size, etc.). The image of the object having a size similar to that of the candidate is preferably presented in actual size.

Furthermore, while the presentation control unit 126 controls presentation of brief audio information such as “how about this color tone?”, it may control presentation of the color of the candidate by graphics. Furthermore, while the presentation control unit 126 controls presentation of brief audio information such as “how about this weight?”, it may control presentation such that the weight of the candidate is understood by graphics. More specifically, the presentation by which the weight of the candidate is understood may be presentation of an image of an object having a weight similar to that of the candidate.

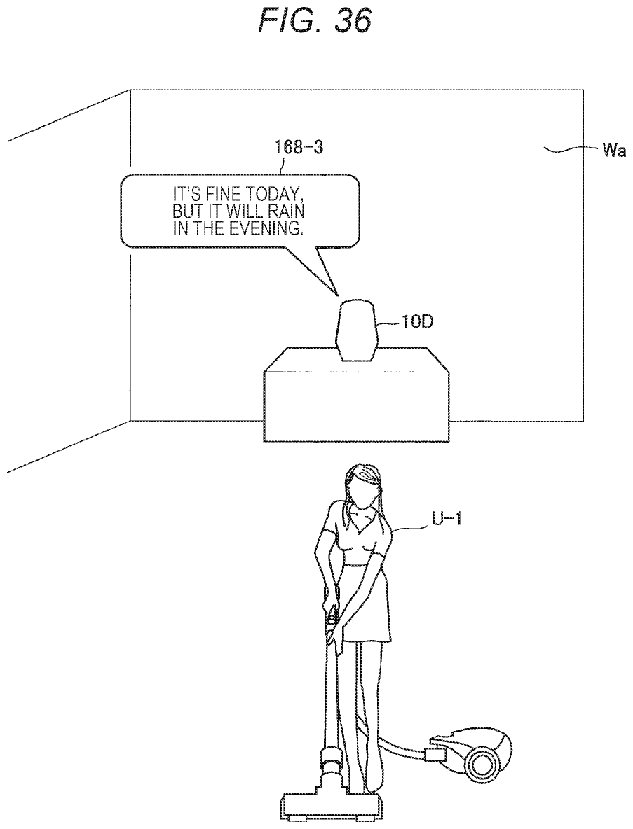

Next, another specific example of the presentation information will be described. FIG. 36 is a diagram illustrating another exemplary presentation in the audio-based presentation mode. Here, a case where the user U-1 inputs the request “presentation of today's weather report” by utterance of “tell me today's weather” is assumed. In FIG. 36, the wall surface Wa is illustrated as a screen on which the video information is presented. However, the user U-1 is not viewing the screen (e.g., because he/she is doing cleaning). Accordingly, the presentation control unit 126 determines that the posture information of the user U-1 satisfies the screen non-viewing condition, and controls the presentation in the audio-based presentation mode.

As described above, in the audio-based presentation mode, the presentation control unit 126 may present only the audio information to the user U-1 (video information may not be presented). At this time, the audio information is preferably presented such that the user U-1 can sufficiently understand the response contents only by the audio information. In the example illustrated in FIG. 36, audio information 168-3 includes today's weather report.

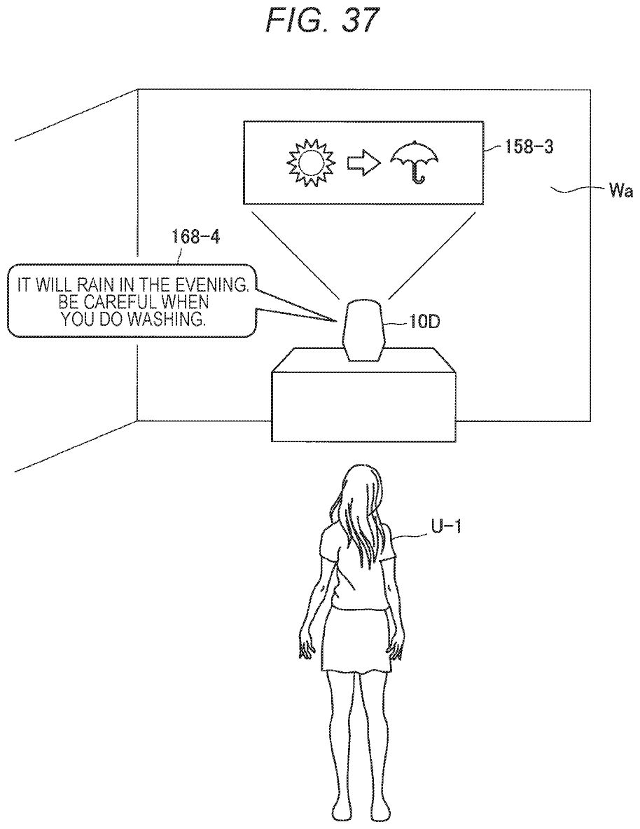

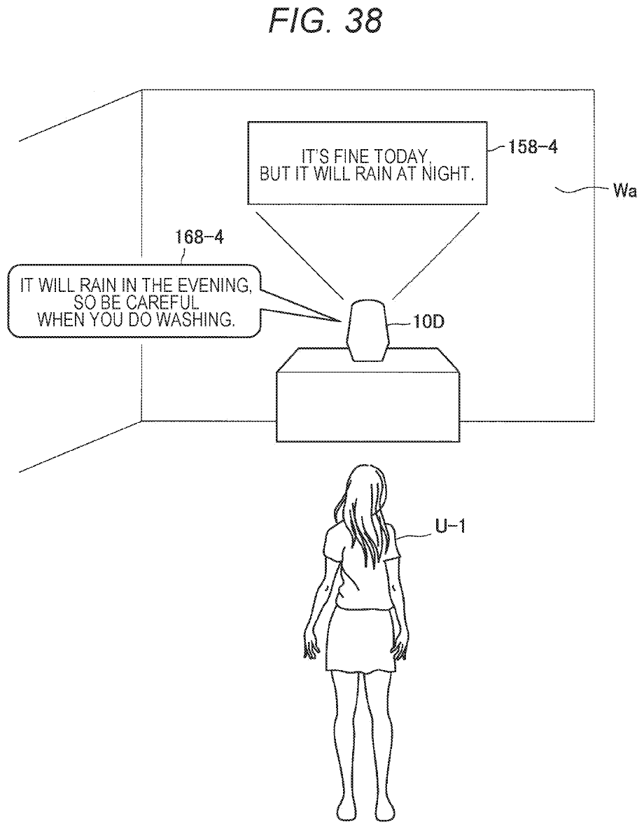

FIGS. 37 and 38 are diagrams illustrating another exemplary presentation in the audio video presentation mode. Here again, the case where the user U-1 inputs the request “presentation of today's weather report” by utterance of “tell me today's weather” is assumed. In the examples illustrated in FIGS. 37 and 38, the user U-1 is viewing the screen. Accordingly, the presentation control unit 126 determines that the posture information of the user U-1 satisfies the screen viewing condition, and controls the presentation in the audio video presentation mode.

As described above, in the audio video presentation mode, the presentation control unit 126 may present both the video information and the audio information to the user U-1. For example, the video information presented in the audio video presentation mode may include at least one of graphics or text data. In the example illustrated in FIG. 37, the presentation control unit 126 controls the presentation of the weather report using graphics as video information 158-3. At this time, the audio information presented in the audio video presentation mode may include additional audio information. In the example illustrated in FIG. 37, the presentation control unit 126 controls presentation of audio information 168-4 including additional audio information “be careful when you do washing”.

In the example illustrated in FIG. 38, the presentation control unit 126 controls the presentation of the weather report using text data as video information 158-4. Furthermore, in the example illustrated in FIG. 38, in a similar manner to the example illustrated in FIG. 37, the presentation control unit 126 controls the presentation of the audio information 168-4 including the additional audio information “be careful when you do washing”.

The functional details of the information processing system 1D according to the fourth embodiment have been described as above.

[5.4. Exemplary Operation]

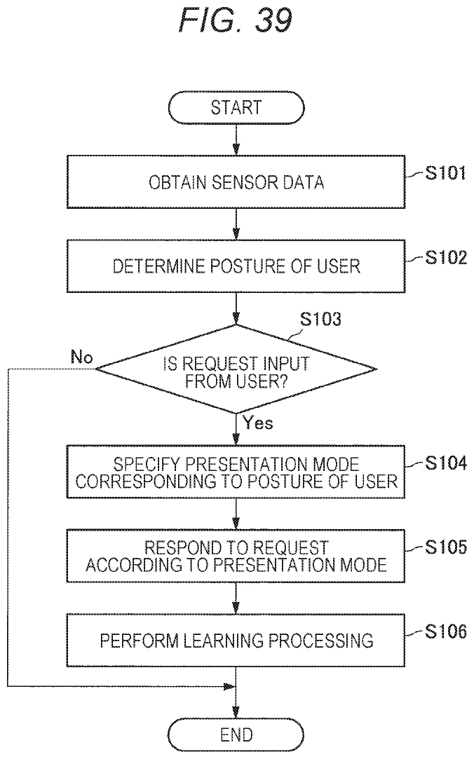

Next, exemplary operation of the information processing system 1D according to the fourth embodiment will be described. FIG. 39 is a flowchart illustrating exemplary operation of presenting presentation information to the user U-1 in response to a request input by the user U-1. Note that, although an example in which, in a case where a request is input by the user U-1, presentation information is presented to the user U-1 in response to the request will be mainly described here, the presentation information may be presented to the user U-1 regardless of whether or not the request is input as described above.

As illustrated in FIG. 39, the posture determination unit 124 obtains sensor data (S101), and determines the posture of the user U-1 on the basis of the sensor data (S102). As a result, the posture determination unit 124 obtains posture information of the user U-1. As described above, the posture information may include the orientation of the face of the line of sight, may include pose information, or may include behavior information. The posture information acquisition unit 125 obtains the posture information of the user U-1 determined by the posture determination unit 124.

Then, in a case where no request is input by the user U-1 (“No” in S103), the presentation control unit 126 terminates the operation. On the other hand, in a case where the request is input by the user U-1 (“Yes” in S103), the presentation control unit 126 specifies the presentation mode corresponding to the posture of the user U-1 (S104). Specifically, in a case where the posture information satisfies the screen viewing condition, the presentation control unit 126 specifies the audio video presentation mode associated with the screen viewing condition. On the other hand, in a case where the posture information satisfies the screen non-viewing condition, the presentation control unit 126 specifies the audio-based presentation mode associated with the screen non-viewing condition.

The presentation control unit 126 controls a response (presentation of presentation information) to the request according to the specified presentation mode (S105). Then, the learning processing unit 127 obtains the state of the user U-1 after the response to the request according to the specified presentation mode is performed. Then, in a case where the state of the user U-1 is in a predetermined state, the learning processing unit 127 performs learning processing of changing the association between the condition and the presentation mode (S106), and terminates the operation.

For example, in a case where, after the response is performed according to the audio video presentation mode associated with the screen viewing condition, a predetermined change operation performed by the user U-1 or a state in which the user U-1 is not viewing the screen is detected, the learning processing unit 127 performs a change such that the audio-based presentation mode is associated with the screen viewing condition. On the other hand, in a case where, after the response is performed according to the audio-based presentation mode associated with the screen non-viewing condition, a predetermined change operation performed by the user U-1 or a state in which the user U-1 is viewing the screen is detected, the learning processing unit 127 performs a change such that the audio video presentation mode is associated with the screen non-viewing condition.

The exemplary operation of the information processing system 1D according to the fourth embodiment has been described as above.

[5.5. Autonomous Presentation from Agent]

As described above, the presentation information for the user U-1 may be presented regardless of whether or not the request is input by the user U-1. In other words, the agent 10D may autonomously present the presentation information to the user U-1 even if no request is input by the user U-1. Even in this case, the presentation control unit 126 may control the presentation of the presentation information to the user U-1 according to the presentation mode corresponding to the posture information of the user U-1.

However, in a case where the agent 10D presents the presentation information to the user U-1 with no advance notice, the user U-1 is considered not to be viewing the screen at the timing of presenting the presentation information. In view of the above, the presentation control unit 126 may guide the user U-1 to view the screen using a predetermined voice output (e.g., sound effect (SE), TTS, etc.), and then specify the presentation mode on the basis of the posture information of the user U-1.

[5.6. Variation of Display Unit and Screen]

In the foregoing description, a case where a display unit 150 is a stationary projector (e.g., single focus projector) has been mainly assumed. However, the position at which the display unit 150 is placed is not limited. Furthermore, a case where the position of the screen on which the video information is displayed by the display unit 150 is the wall surface has been mainly assumed. However, the display unit 150 or the position of the screen on which the video information is displayed by the display unit 150 is not limited to the wall surface. Hereinafter, variations of the display unit 150 and the screen will be described.

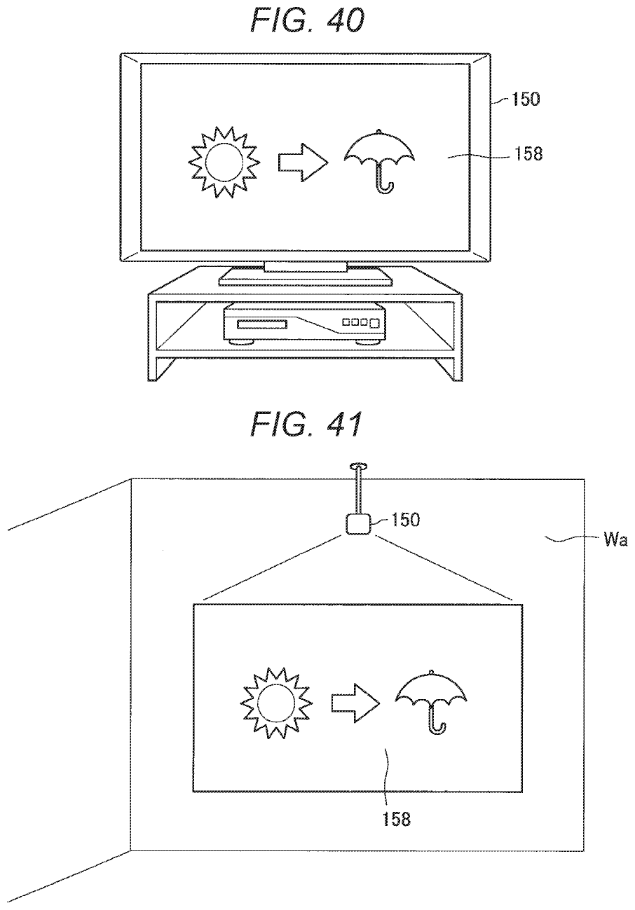

FIG. 40 is a diagram illustrating a first variation of the display unit 150 and the screen. As illustrated in FIG. 40, the display unit 150 may be a television device. Referring to FIG. 40, video information 158 is displayed by a television device as an example of the display unit 150. At this time, the screen on which the video information 158 is displayed by the display unit 150 is the front face of the television device.

FIG. 41 is a diagram illustrating a second variation of the display unit 150 and the screen. As illustrated in FIG. 41, the display unit 150 may be a projector installed on a ceiling. At this time, the projector installed on the ceiling may be a single focus projector, may be an omnidirectional projector capable of projecting an image in all directions, or may be a driven type projector capable of controlling a display position (projection direction). At this time, as illustrated in FIG. 41, the position of the screen on which the video information is displayed by the display unit 150 may be the wall surface Wa.

FIG. 42 is a diagram illustrating a third variation of the display unit 150 and the screen. As illustrated in FIG. 42, the display unit 150 may be a stationary projector (e.g., single focus projector) placed on a table Ta. At this time, as illustrated in FIG. 42, the position of the screen on which the video information is displayed by the display unit 150 may be the upper surface of the table Ta.

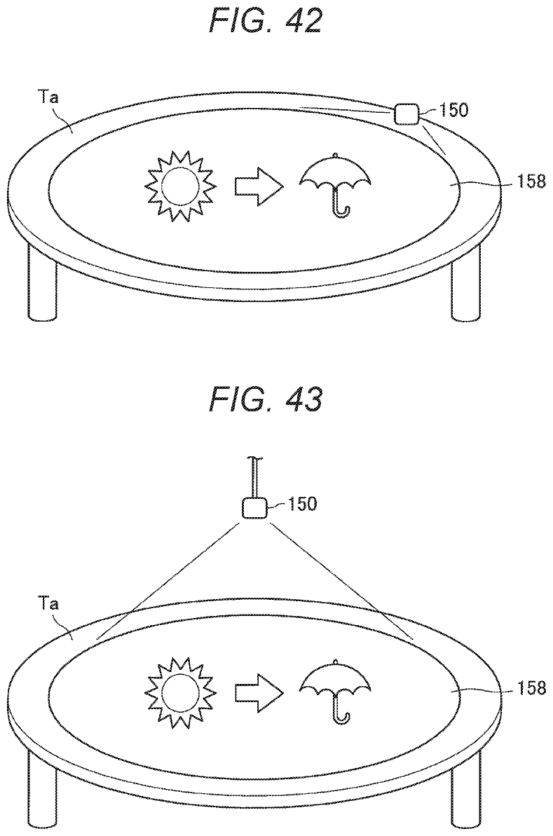

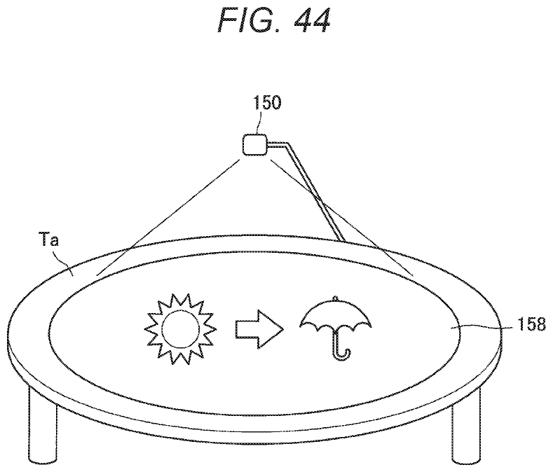

FIG. 43 is a diagram illustrating a fourth variation of the display unit 150 and the screen. As illustrated in FIG. 43, the display unit 150 may be a projector installed on the ceiling above the table Ta. At this time, the projector installed on the ceiling may be a single focus projector, or may be a driven type projector capable of controlling a display position (projection direction). At this time, as illustrated in FIG. 43, the position of the screen on which the video information is displayed by the display unit 150 may be the upper surface of the table Ta.

FIG. 44 is a diagram illustrating a fifth variation of the display unit 150 and the screen. As illustrated in FIG. 44, the display unit 150 may be a projector (e.g., single focus projector) attached to the table Ta such that a video is projected downward from the upper part of the table Ta. At this time, as illustrated in FIG. 44, the position of the screen on which the video information is displayed by the display unit 150 may be the upper surface of the table Ta.

[5.7. Exemplary Presentation Corresponding to Multiple Users]

In the foregoing description, exemplary presentation of the presentation information in consideration of one user (user U-1) has been described. Hereinafter, exemplary presentation of the presentation information in consideration of a plurality of users (users U-1 to U-N) will be described. More specifically, exemplary presentation of the presentation information in consideration of situations of the plurality of users will be described.

A situation of the user is not limited. For example, the situation of the user may include a posture of the user (e.g., which of the screen viewing condition and the screen non-viewing condition the posture information satisfies, etc.).

Alternatively, the situation of the user may include a position of the user (e.g., distance from the screen, etc.).
Alternatively, the situation of the user may include an attribute of the user (e.g., gender, age (e.g., an adult or a child), whether or not the user belongs to the family member set in the agent, language, etc.). Alternatively, the situation of the user may include whether or not the user is the person who has input the request (utterer), whether or not the user is the person to receive the presentation of the presentation information from the agent, and the like.

For example, the posture and the position of the user (e.g., distance from the screen, etc.) can be detected in the manner described above. Furthermore, identification information of the user is associated with the attribute of the user in advance, and in a case where the user is recognized from the image captured by the imaging unit 114 using a face recognition technique, the attribute associated with the identification information of the user may be detected. Whether or not the user is the utterer may be detected on the basis of the incoming direction of the detected utterance voice. Whether or not the user is the person to receive the presentation of the presentation information may be detected on the basis of the contents of the presentation information.

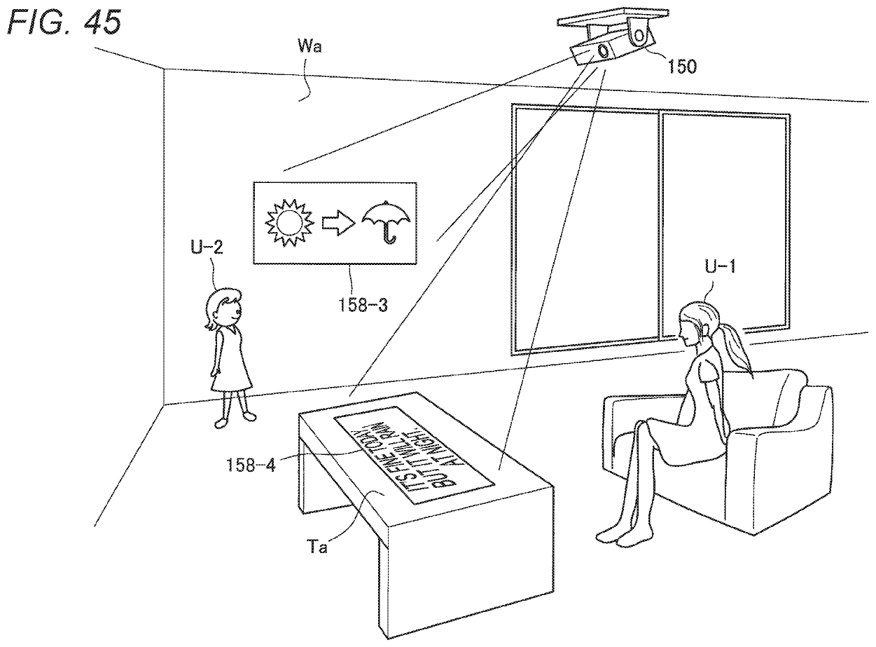

FIG. 45 is a diagram illustrating exemplary presentation of the presentation information in consideration of the situation of the plurality of users. For example, the presentation control unit 126 may perform control such that the presentation information corresponding to the situation of each of the plurality of users is presented. Referring to FIG. 45, there are the user U-1 and the user U-2 as an example of the plurality of users. At this time, the presentation control unit 126 may control presentation of first presentation information corresponding to the situation of the user U-1 and presentation of second presentation information corresponding to the situation of the user U-2.

Specifically, in the example illustrated in FIG. 45, the user U-1 is an adult and the user U-2 is a child. Then, a case where the adult user U-1 inputs the request “presentation of today's weather report” by utterance of “tell me today's weather” is assumed. In such a case, the presentation control unit 126 may control the presentation of the presentation information for adults (e.g., video information 158-4 showing weather in detail or the like) for the adult user U-1. The presentation information for adults may be audio information. Meanwhile, for the child user U-2, presentation of presentation information for children (e.g., video information 158-3 in which a weather mark is largely drawn) may be controlled.

At this time, the presentation information for adults (e.g., video information 158-4 showing the weather in detail, etc.) may be presented in the vicinity of the adult user U-1 (in the example illustrated in FIG. 45, upper surface of the table Ta placed in the vicinity of the adult user U-1). Meanwhile, the presentation information for children (e.g., video information 158-3 in which the weather mark is largely drawn) may be presented in the vicinity of the child user U-2 (in the example illustrated in FIG. 45, wall surface Wa located in the vicinity of the child user U-2).

Alternatively, the presentation control unit 126 may select the user to be prioritized from among the plurality of users, and may control a plurality of pieces of presentation information on the basis of the posture information of the selected user. Control of the plurality of pieces of presentation information corresponding to the posture information of the user may be performed in the manner described above. In other words, in a case where the posture information of the user satisfies the screen viewing condition, the presentation control unit 126 may control the presentation according to the audio video presentation mode. Furthermore, in a case where the posture information of the user satisfies the screen non-viewing condition, the presentation control unit 126 may control the presentation according to the audio-based presentation mode.

The user to be prioritized may be selected in any way. For example, the presentation control unit 126 may select the utterer as a user to be prioritized from among the plurality of users. Alternatively, the presentation control unit 126 may select the person to receive the presentation of the presentation information as a user to be prioritized from among the plurality of users.

Alternatively, the presentation control unit 126 may select the person closest to the screen as a user to be prioritized from among the plurality of users.

Furthermore, the presentation control unit 126 may select an adult as a user to be prioritized from among the plurality of users. Alternatively, the presentation control unit 126 may select a child as a user to be prioritized from among the plurality of users. For example, whether to select an adult or to select a child may be determined on the basis of the contents of the presentation information.

Furthermore, the presentation control unit 126 may select the person who has the most difficulty in viewing the screen as a user to be prioritized from among the plurality of users. In other words, the presentation control unit 126 may select the audio-based presentation mode if there is even one person who satisfies the screen non-viewing condition. On the other hand, the presentation control unit 126 may select the audio video presentation mode if all users satisfy the screen viewing condition.

Furthermore, the presentation control unit 126 may select a person belonging to the family member set in the agent as a user to be prioritized from among the plurality of users. In other words, the presentation control unit 126 may not be required to select a person not belonging to the family member set in the agent (e.g., visitor at the house or the like).

Furthermore, the presentation control unit 126 may select a person who uses the language same as the language set in the agent (language used by the agent for the presentation information) as a user to be prioritized from among the plurality of users. For example, in a case where the agent uses the Japanese language for the presentation information, the presentation control unit 126 may select a person who uses the Japanese language as a user to be prioritized from among the plurality of users.

In the foregoing, the fourth embodiment has been described.

<6. Exemplary Hardware Configuration>

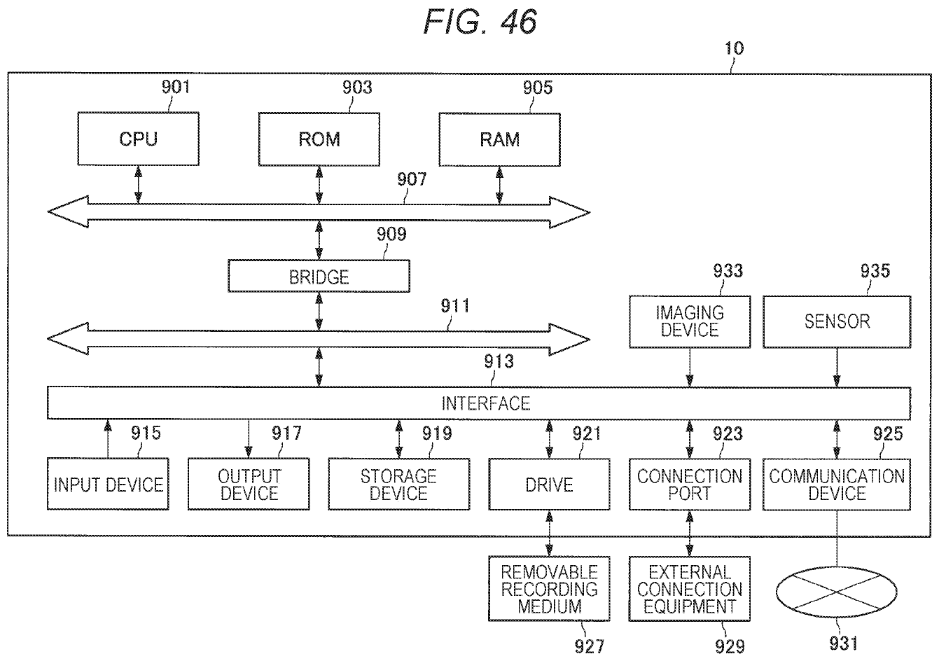

Next, with reference to FIG. 46, an exemplary hardware configuration of the information processing apparatus (agent) 10 according to the embodiments of the present disclosure will be described. FIG. 46 is a block diagram illustrating the exemplary hardware configuration of the information processing apparatus 10 according the embodiments of the present disclosure. Note that a hardware configuration of the server device 30 according to the embodiments of the present disclosure can also be achieved in a similar manner to the exemplary hardware configuration of the information processing apparatus 10 illustrated in FIG. 46.

As illustrated in FIG. 46, the information processing apparatus 10 includes a central processing unit (CPU) 901, a read only memory (ROM) 903, and a random access memory (RAM) 905. Furthermore, the information processing apparatus 10 may include a host bus 907, a bridge 909, an external bus 911, an interface 913, an input device 915, an output device 917, a storage device 919, a drive 921, a connection port 923, and a communication device 925. Moreover, the information processing apparatus 10 may include an imaging device 933, and a sensor 935 as necessary. Instead of or in addition to the CPU 901, the information processing apparatus 10 may include a processing circuit referred to as a digital signal processor (DSP) or an application specific integrated circuit (ASIC).

The CPU 901 functions as an arithmetic processing unit and a control unit, and controls overall operation in the information processing apparatus 10 or a part thereof in accordance with various programs recorded in the ROM 903, the RAM 905, the storage device 919, or a removable recording medium 927. The ROM 903 stores programs to be used by the CPU 901, operation parameters, and the like. The RAM 905 temporarily stores programs to be used in the execution of the CPU 901, parameters that appropriately change in the execution, and the like. The CPU 901, the ROM 903, and the RAM 905 are mutually connected by the host bus 907 including an internal bus such as a CPU bus. Moreover, the host bus 907 is connected to the external bus 911, such as a peripheral component interconnect/interface (PCI) bus, via the bridge 909.

The input device 915 is a device operated by the user, which is, for example, a mouse, a keyboard, a touch panel, a button, a switch, a lever, and the like. The input device 915 may include a microphone for detecting user's voice. The input device 915 may be, for example, a remote control device using infrared rays or other radio waves, or may be external connection equipment 929 such as a mobile phone supporting operation of the information processing apparatus 10. The input device 915 includes an input control circuit that generates an input signal on the basis of the information input by the user and outputs it to the CPU 901. The user operates the input device 915 to input, on the information processing apparatus 10, various kinds of data or to provide an instruction for processing operation. Furthermore, the imaging device 933 to be described later can also function as an input device by imaging a motion of the hand of the user, a finger of the user, and the like. At this time, a pointing position may be determined according to the motion of the hand or the orientation of the finger.

The output device 917 includes a device capable of visually or aurally notifying the user of the obtained information. The output device 917 may be, for example, a display device such as a liquid crystal display (LCD), a plasma display panel (PDP), an organic electro-luminescence (EL) display, and a projector, a display device of a hologram, a voice output device such as a speaker, and headphone, a printer device, and the like. The output device 917 outputs the result obtained by the processing of the information processing apparatus 10 as a video of a text, image, or the like, or as a voice of voice, audio sound, or the like. Furthermore, the output device 917 may include a light or the like for illuminating the surroundings.

The storage device 919 is a device for storing data, which is an example of a storage unit of the information processing apparatus 10. The storage device 919 includes, for example, a magnetic storage unit device such as a hard disk drive (HDD), a semiconductor storage device, an optical storage device, a magneto-optical storage device, or the like. The storage device 919 stores programs to be executed by the CPU 901, various kinds of data, various kinds of data obtained from the outside, and the like.

The drive 921 is a reader/writer for the removable recording medium 927, such as a magnetic disk, an optical disk, a magneto-optical disk, or a semiconductor memory, which is incorporated in the information processing apparatus 10 or externally attached thereto. The drive 921 reads the information recorded in the attached removable recording medium 927, and outputs it to the RAM 905. Furthermore, the drive 921 writes a record in the attached removable recording medium 927.

The connection port 923 is a port for directly connecting a device to the information processing apparatus 10. The connection port 923 may be, for example, a universal serial bus (USB) port, an IEEE 1394 port, a small computer system interface (SCSI) port, or the like. Furthermore, the connection port 923 may be an RS-232C port, an optical audio terminal, a high-definition multimedia interface (HDMI) (registered trademark) port, or the like. The information processing apparatus 10 can exchange various kinds of data with the external connection equipment 929 by the external connection equipment 929 being connected to the connection port 923.

The communication device 925 is, for example, a communication interface including a communication device or the like for connecting to the communication network 931. The communication device 925 may be, for example, a communication card for wired or wireless local area network (LAN), Bluetooth (registered trademark), wireless USB (WUSB), or the like. Furthermore, the communication device 925 may be a router for optical communication, a router for asymmetric digital subscriber line (ADSL), a modem for various kinds of communication, or the like. For example, the communication device 925 transmits and receives signals and the like using a predetermined protocol such as TCP/IP with the Internet and another communication device. Furthermore, the communication network 931 connected to the communication device 925 is a network connected by wire or wirelessly, which is, for example, the Internet, a home LAN, infrared communication, radio wave communication, satellite communication, or the like.

The imaging device 933 is, for example, a device that images a real space to generate a captured image using various members such as an imaging element such as a charge coupled device (CCD), or a complementary metal oxide semiconductor (CMOS), and a lens for controlling imaging of a subject image on the imaging element. The imaging device 933 may image a still image, or may image a moving image.

The sensor 935 is, for example, various sensors such as a distance measuring sensor, an acceleration sensor, a gyroscope sensor, a geomagnetic sensor, a light sensor, and a sound sensor. The sensor 935 obtains information associated with a state of the information processing apparatus 10 itself, which is, for example, a posture of the casing of the information processing apparatus 10, and the like, and information associated with a surrounding environment of the information processing apparatus 10, such as brightness and noise around the information processing apparatus 10. Furthermore, the sensor 935 may include a global positioning system (GPS) sensor that receives a GPS signal and measures the latitude, longitude, and altitude of the device.

### 7. Conclusion

As described above, according to the embodiments of the present disclosure, there is provided an information processing apparatus including a detection unit that detects a context associated with a user, and a request processing unit that determines, on the basis of the context, which of a first request and a second request should be preferentially processed. According to such a configuration, a technique capable of more appropriately determining a request to be preferentially processed is provided.

Furthermore, according to the embodiments of the present disclosure, there is provided an information processing apparatus including a posture information acquisition unit that obtains posture information of a user, and a presentation control unit that controls presentation of presentation information to the user, and the presentation control unit controls a plurality of pieces of the presentation information having different aspects on the basis of the posture information. According to such a configuration, a technique capable of controlling the plurality of pieces of presentation information to be presented to the user as further desired by the user is provided.

As described above, although the preferred embodiments of the present disclosure have been described in detail with reference to the accompanying drawings, the technical scope of the present disclosure is not limited to such examples. It is obvious that those skilled in the art in the technical field of the present disclosure may find various alterations and modifications within the scope of the appended claims, and it should be understood that such alterations and modifications are also naturally within the technical scope of the present disclosure.

For example, the embodiments described above may be appropriately combined. More specifically, any one of the first embodiment to the third embodiment may be combined with the fourth embodiment. More specifically, in any one of the first embodiment to the third embodiment, it is determined which request should be preferentially processed, and on the basis of the determination result of which request should be preferentially processed, a response to the request may be presented to the user as presentation information in the fourth embodiment.

Furthermore, it is also possible to create a program for causing hardware incorporated in the computer, such as a CPU, a ROM, a RAM, and the like, to exert functions similar to those of the control unit 120 described above. Furthermore, a computer-readable recording medium in which the program is recorded can also be provided.

For example, the position of each configuration is not particularly limited as long as the above-described operation of the information processing apparatus 10 and the server device 30 can be achieved. A part of the processing of each unit in the information processing apparatus 10 may be performed by the server device 30. As a specific example, a part of or all of the blocks of the control unit 110 in the information processing apparatus 10 may be present in the server device 30 or the like. Furthermore, a part of the processing of each unit in the server device 30 may be performed by the information processing apparatus 10.

Furthermore, the effects described in the present specification are merely illustrative or exemplary, and are not limited. That is, the technique according to the present disclosure can exert other effects obvious to those skilled in the art from the disclosure of the present specification together with or instead of the effects described above.

Note that the following configurations are also within the technical scope of the present disclosure.

(1)

An information processing apparatus, including:

a detection unit that detects a context associated with a user; and

a request processing unit that determines, on the basis of the context, which of a first request and a second request should be preferentially processed.

(2)

The information processing apparatus according to (1) described above, in which

the context associated with the user includes at least one of time information associated with the user, weather information associated with the user, environmental information associated with the user, or content of utterance associated with the user.

(3)

The information processing apparatus according to (1) or (2) described above, in which

the request processing unit determines which of the first request and the second request should be preferentially processed on the basis of comparison between a priority score of the first request and a priority score of the second request.

(4)

The information processing apparatus according to (3) described above, in which

the request processing unit obtains the priority score of the first request on the basis of the context and attribute information of the first request, and obtains the priority score of the second request on the basis of the context and attribute information of the second request.

(5)

The information processing apparatus according to (4) described above, in which

the attribute information of each of the first request and the second request includes an attribute type and an attribute value corresponding to the attribute type.

(6)

The information processing apparatus according to (5) described above, in which

the attribute type includes information indicating a user or information indicating a device.

(7)

The information processing apparatus according to (6) described above, in which

in a case where the attribute type includes the information indicating a user, the request processing unit obtains the attribute value recognized on the basis of a voice recognition result or a face recognition result.

(8)

The information processing apparatus according to any one of (5) to (7) described above, in which

in a case where the detection unit detects a first context and a second context and attribute types corresponding to the first context and the second context are the same, the request processing unit obtains the priority score of each of the first request and the second request on the basis of computing of priority scores associated with the same attribute information corresponding to each of the first context and the second context.

(9)

The information processing apparatus according to any one of (5) to (7) described above, in which

in a case where the detection unit detects a first context and a second context and attribute types corresponding to the first context and the second context are different, the request processing unit obtains the priority score of each of the first request and the second request on the basis of computing of priority scores associated with different attribute information corresponding to each of the first context and the second context.

(10)

The information processing apparatus according to any one of (4) to (9) described above, in which

the request processing unit obtains relevant information of another user having a predetermined analogous relationship with the user of the information processing apparatus as relevant information in which the context, the attribute information, and the priority score are associated with each other.

(11)

The information processing apparatus according to (10) described above, in which

the request processing unit associates a certainty factor based on feedback from the user with the relevant information, and in a case where a certainty factor associated with at least one of the attribute information of each of the first request or the second request is lower than a predetermined threshold value, the request processing unit does not determine which of the first request and the second request should be preferentially processed.

(12)

The information processing apparatus according to any one of (1) to (11) described above, in which

the first request is a request in processing, and

the second request is a newly input request.

(13)

The information processing apparatus according to (12) described above, further including:

an execution control unit that controls output of predetermined output information in a case where the execution control unit determines that the newly input request should be preferentially processed.

(14)

The information processing apparatus according to (12) described above, in which

the request processing unit includes an execution control unit that continues to process the request in processing in a case where the execution control unit determines that the request in processing should be preferentially processed.

(15)

The information processing apparatus according to any one of (1) to (14) described above, in which

the information processing apparatus includes an agent that controls execution of processing of the first request and the second request on behalf of the user.

(16)

The information processing apparatus according to any one of (1) to (15) described above, in which

the request processing unit sets a request from the user as an execution target in a case where it is determined that the request from the user should be processed by the information processing apparatus among a plurality of information processing apparatuses.

(17)

The information processing apparatus according to (16) described above, in which

in a case where the information processing apparatus is closest to the user, it is determined that the information processing apparatus among the plurality of information processing apparatuses should process the request from the user.

(18)

The information processing apparatus according to (16) or (17) described above, in which

in a case where the information processing apparatus among the plurality of information processing apparatuses does not have a request to be processed, it is determined that the information processing apparatus should process the request from the user.

(19)

A method for processing information, including:

detecting a context associated with a user; and

determining, using a processor, which of a first request and a second request should be preferentially processed on the basis of the context.

(20)

A program for causing a computer to function as an information processing apparatus including:

a detection unit that detects a context associated with a user; and

a request processing unit that determines, on the basis of the context, which of a first request and a second request should be preferentially processed.

### REFERENCE SIGNS LIST

1 (1A to 1D) Information processing system
10 (10A to 10D) Agent (Information processing apparatus)
20 Controller
30 (30A to 30B) Server device
110 Control unit
113 Sound collection unit
114 Imaging unit
115 Distance detection unit
116 Receiving unit
120 Control unit
120 Control unit
121 Detection unit
122 Request processing unit
123 Execution control unit
124 Posture determination unit
125 Posture information acquisition unit
126 Presentation control unit
127 Learning processing unit
130 Storage unit
140 Communication unit
150 Display unit
160 Sound output unit
310 Control unit
311 Distance acquisition unit
312 Selection unit
313 Execution command output unit
340 Communication unit
350 Storage unit

1. An information processing apparatus, comprising:
a detection unit that detects a context associated with a user; and
a request processing unit that determines, on a basis of the context, which of a first request and a second request should be preferentially processed.

2. The information processing apparatus according to claim 1, wherein
the context associated with the user includes at least one of time information associated with the user, weather information associated with the user, environmental information associated with the user, or content of utterance associated with the user.

3. The information processing apparatus according to claim 1, wherein
the request processing unit determines which of the first request and the second request should be preferentially processed on a basis of comparison between a priority score of the first request and a priority score of the second request.

4. The information processing apparatus according to claim 3, wherein
the request processing unit obtains the priority score of the first request on a basis of the context and attribute information of the first request, and obtains the priority score of the second request on a basis of the context and attribute information of the second request.

5. The information processing apparatus according to claim 4, wherein
the attribute information of each of the first request and the second request includes an attribute type and an attribute value corresponding to the attribute type.

6. The information processing apparatus according to claim 5, wherein
the attribute type includes information indicating a user or information indicating a device.

7. The information processing apparatus according to claim 6, wherein
in a case where the attribute type includes the information indicating a user, the request processing unit obtains the attribute value recognized on a basis of a voice recognition result or a face recognition result.

8. The information processing apparatus according to claim 5, wherein
in a case where the detection unit detects a first context and a second context and attribute types corresponding to the first context and the second context are the same, the request processing unit obtains the priority score of each of the first request and the second request on a basis of computing of priority scores associated with the same attribute information corresponding to each of the first context and the second context.

9. The information processing apparatus according to claim 5, wherein
in a case where the detection unit detects a first context and a second context and attribute types corresponding to the first context and the second context are different, the request processing unit obtains the priority score of each of the first request and the second request on a basis of computing of priority scores associated with different attribute information corresponding to each of the first context and the second context.

10. The information processing apparatus according to claim 4, wherein
the request processing unit obtains relevant information of another user having a predetermined analogous relationship with the user of the information processing apparatus as relevant information in which the context, the attribute information, and the priority score are associated with each other.

11. The information processing apparatus according to claim 10, wherein
the request processing unit associates a certainty factor based on feedback from the user with the relevant information, and in a case where a certainty factor associated with at least one of the attribute information of each of the first request or the second request is lower than a predetermined threshold value, the request processing unit does not determine which of the first request and the second request should be preferentially processed.

12. The information processing apparatus according to claim 1, wherein
the first request is a request in processing, and
the second request is a newly input request.

13. The information processing apparatus according to claim 12, further comprising:
an execution control unit that controls output of predetermined output information in a case where the execution control unit determines that the newly input request should be preferentially processed.

14. The information processing apparatus according to claim 12, wherein
the request processing unit includes an execution control unit that continues to process the request in processing in a case where the execution control unit determines that the request in processing should be preferentially processed.

15. The information processing apparatus according to claim 1, wherein
the information processing apparatus comprises an agent that controls execution of processing of the first request and the second request on behalf of the user.

16. The information processing apparatus according to claim 1, wherein
the request processing unit sets a request from the user as an execution target in a case where it is determined that the request from the user should be processed by the information processing apparatus among a plurality of information processing apparatuses.

17. The information processing apparatus according to claim 16, wherein
in a case where the information processing apparatus is closest to the user, it is determined that the information processing apparatus among the plurality of information processing apparatuses should process the request from the user.

18. The information processing apparatus according to claim 16, wherein
in a case where the information processing apparatus among the plurality of information processing apparatuses does not have a request to be processed, it is determined that the information processing apparatus should process the request from the user.

19. A method for processing information, comprising:
detecting a context associated with a user; and
determining, using a processor, which of a first request and a second request should be preferentially processed on a basis of the context.

20. A program for causing a computer to function as an information processing apparatus including:
a detection unit that detects a context associated with a user; and
a request processing unit that determines, on a basis of the context, which of a first request and a second request should be preferentially processed.
